(19) United States
(12) Patent Application Publication
(10) Pub. No.: US 2025/0001368 A1
(43) Pub. Date: Jan. 2, 2025

(54) COVALENT ORGANIC FRAMEWORK MEMBRANES, METHODS AND USES THEREOF

(71) Applicant: NATIONAL UNIVERSITY OF SINGAPORE, Singapore (SG)

(72) Inventors: DAN ZHAO, Singapore (SG); Hao YANG, Singapore (SG); Jie WU, Singapore (SG); Jinhui XU, Singapore (SG)

(21) Appl. No.: 18/292,622

(22) PCT Filed: Jul. 27, 2022
(86) PCT No.: PCT/SG2022/050537

§ 371 Date: Jan. 26, 2024

(30) Foreign Application Priority Data
Jul. 28, 2021 (SG) 10202108256S

(51) Int. Cl. B01D 69/12; B01D 61/02; B01D 69/02; B01D 69/10; B01D 71/60; B01J 23/30; B01J 23/92; B01J 31/18; B01J 31/22; B01J 31/40; B01J 38/00; C01B 32/318; C01B 32/348; C01B 32/372; C08G 12/08; C08G 16/02

(52) U.S. Cl. CPC B01D 69/1251; B01D 61/027; B01D 61/0271; B01D 69/02; B01D 69/105; B01D 69/108; B01D 71/60; B01J 23/30; B01J 23/92; B01J 31/1815; B01J 31/2295; B01J 31/4038; B01J 38/00; C01B 32/318; C01B 32/348; C01B 32/372; C08G 12/08; C08G 16/0206; B01D 2325/02831; B01D 2325/02832; B01D 2325/20; B01D 2325/28; B01J 2531/008; B01J 2531/821; B01J 2531/827; C08J 2335/04

(57) ABSTRACT

This disclosure concerns a method of forming a covalent organic framework (COF) membrane, comprising forming a membrane substrate by impregnating a porous polymer with a pore-forming agent in order to form an impregnated polymer, at least partially carbonising the impregnated polymer at a temperature of about 150° C. to about 500° C. in order to form the membrane substrate, and interfacially polymerising amino monomers and acyl monomers on a surface of the membrane substrate in order to form the COF membrane. The membrane substrate is characterised by a crystallinity of about 10% to about 70% relative to the porous polymer. The disclosure also concerns the COF membrane thereof, and the use of the COF membrane in catalyst recovery.

### FIELD

The present disclosure relates to covalent organic framework membranes and uses thereof. The present disclosure also relates to methods of forming the presently disclosed covalent organic framework membranes.

### BACKGROUND

In the membrane filtration art, substrates used to support the membrane are equally as important as the membrane itself. In fact, the selection of an appropriate substrate can affect the overall performance of the membrane and hence the filtration. However, conventional substrates fall short when organic solvents are involved because of the severe swelling of the polymeric chains in the substrates.

One commonly used substrate is polyacrylonitrile (PAN) substrate. PAN substrates are used either in flat-sheet or hollow fiber forms in organic solvent nanofiltration and reverse osmosis. To improve its usability, PAN is often blended with other polymers to alter the final pore size distribution. For example, PAN hollow fiber membrane by blending it with methyl methacrylate. However, such composites are brittle and are not easy to handle in an industrial setting. Commercial PAN substrates also have poor organic solvent resistance, low porosity and low flux for nanofiltration. The blending with other polymeric additives cannot effectively solve these problems.

A further issue is that the membrane and the substrate must also be compatible and suitably adhered to each other for the membrane to perform its function. For example, back pressure during filtration can cause the membrane to delaminate from the substrate, thereby damaging the membranes and rendering it unusable.

It would be desirable to overcome or ameliorate at least one of the above-described problems.

### SUMMARY OF INVENTION

The present invention is predicated on the understanding that the tradeoff between the solvent resistance and mechanical strength of the conventional polymeric substrates can be overcome by the interplay of polymers and pore-forming agents. In addition to using the pore-forming agents to control the pore size of the substrates, by carbonising the polymer in the presence of the pore-forming agents at a suitable temperature, the resultant substrate can have an improved solvent resistance and acceptable mechanical strength.

Further, covalent organic framework (COF) layer can be prepared on these carbonised membrane substrates through interfacial polymerisation to give a membrane with high flux, high selectivity, and excellent solvent resistance. These layers combine synergistically (or at least additively) to give COF membranes which have robust structures, good chemical stability and well-defined pore sizes. The application of these COF membranes in organic solvent nanofiltration for both dye rejection and catalyst recovery highlights their values in high value-added industrial separation processes.

The present invention provides a method of forming a covalent organic framework (COF) membrane, comprising:
i) forming a membrane substrate by:
   a) impregnating a porous polymer with a pore-forming agent in order to form an impregnated polymer;
   b) at least partially carbonising the impregnated polymer at a temperature of about 150° C. to about 500° C. in order to form the membrane substrate;
   wherein the membrane substrate is characterised by a crystallinity of about 10% to about 70% relative to the porous polymer; and
ii) interfacially polymerising amino monomers and acyl monomers on a surface of the membrane substrate in order to form the COF membrane;
wherein the acyl monomers are aldehyde monomers.

By varying the amine monomers and/or the aldehyde monomers, the pore size of the COF membrane can readily be adjusted to meet the different separation requirements in industry. The COF membranes have well-defined pore channels which provide high fluxes for solvents. The COF membranes are stable in polar protic solvents, nonpolar aprotic solvents as well as polar aprotic solvents for up to 60 days. This allows these COF membranes to be used in practical applications involving aggressive organic solvents.

In some embodiments, the amino monomer comprises at least two amino moieties.

In some embodiments, the amino monomer is selected from p-phenylenediamine (PDA), hydrazine hydrate (HZ), 1,3,5-tris (4-aminephenyl)benzene (TAPB), 3,3-dihydroxybenzidine (DHBD), 2,2′-bipyridine-5,5′-diamine, 4,4′-azodianiline, 4,4′,4″-(1,3,5-triazine-2,4,6-triyl)trianiline, 4,4′,4″-(1,3,5-triazine-2,4,6-triyl) tris (1,1′-biphenyl)trianiline, benzidine, 2,5-diethoxy-terephthalohydrazide, 2,5-diaminebenzene-1,4-disulfonic acid, 2,5-diaminebenzenesulfonic acid, triphenylene hexamine, 1,4-phenylenediamine, melamine, 2,5-dimethylbenzene-1,4-diamine or a combination thereof.

In some embodiments, the acyl monomer comprises at least two aldehyde moieties.

In some embodiments, the acyl monomer is selected from 1,3,5-triformylphloroglucinol (Tp), 1,3,5-triformylbenzene, terephthalaldehyde, 4,4′-biphenyldicarboxaldehyde, 2,5-bis (2-propynyloxy)terephthalaldehyde, 2,5-dimethoxyterephthalaldehyde, 4,4′-biphenyldialdehyde, tetrathiafulvalene-tetrabenzaldehyde or a combination thereof.

In some embodiments, the interfacial polymerisation comprises:
a) homogenously coating the surface of the membrane substrate with amino monomers in order to form a surface coated with amino monomers; and
b) homogenously coating the surface coated with amino monomers with acyl monomers; and
c) polymerising the amino monomers to the acyl monomers.

In some embodiments, the amino monomers is provided in an aqueous medium.

In some embodiments, the amino monomers is at a concentration of about 0.1 mM to about 10 mM, or preferably about 1.2 mM.

In some embodiments, the aqueous medium further comprises p-toluene sulfonic acid.

In some embodiments, the step of coating with amino monomers is performed for at least 1 min.

In some embodiments, the acyl monomers is provided in an organic medium.

In some embodiments, the organic medium is mesitylene.

In some embodiments, the acyl monomers is at a concentration of about 0.1 mM to about 10 mM, or preferably about 0.9 mM.

In some embodiments, the step of coating with acyl monomers is performed for at least 1 min, or preferably at least 5 min.

In some embodiments, the polymerisation is performed in the presence of an acid.

In some embodiments, the acid is acetic acid.

In some embodiments, the acid is at a concentration about 0.1 mM to about 10 mM, or preferably about 2.5 mM.

In some embodiments, the polymerisation is performed at a temperature of about 40° C. to about 90° C., or preferably about 60° C.

In some embodiments, the polymerisation is performed for about 2 h to about 60 h, or preferably about 36 h.

In some embodiments, the pore-forming agent is selected from an inorganic metal salt.

In some embodiments, the pore-forming agent is selected from calcium nitrate, calcium nitrite, calcium chloride, magnesium nitrate, magnesium nitrite, magnesium chloride, sodium nitrate, sodium nitrite, sodium carbonate, potassium carbonate, aluminium nitrate, aluminium nitrite, zinc nitrate, ferric nitrate, ferrous nitrate, cupric nitrate, calcium acetate, tetrabutylammonium bromide, sodium pyridine acetate or a combination thereof.

In some embodiments, the porous polymer is selected from polyacrylonitrile (PAN), polyethersulfone (PES), polyvinylidene fluoride (PVDF), polysulfone, sodium alginate, chitosan, polydimethylsiloxane, polyvinyl alcohol, poly (ether-ether-ketone), poly (methyl methacrylate) (PMMA), polytetrafluoroethylene (PTFE) or a combination thereof.

In some embodiments, the impregnation step is performed for at least about 1 h.

In some embodiments, the impregnated polymer is carbonised at a temperature of about 200° C.

In some embodiments, the impregnated polymer is carbonised for about 30 min to about 360 min.

In some embodiments, the impregnated polymer is carbonised in the presence of oxygen.

In some embodiments, the membrane substrate is characterised by a degree of carbonisation relative to the porous polymer of at least about 20%.

In some embodiments, the membrane substrate is characterised by an increase in pore size relative to the porous polymer of about 5 times to about 100 times.

The present invention also provides a covalent organic framework (COF) membrane, comprising:
i) a membrane substrate comprising an at least partially carbonised porous polymer, the membrane substrate having a pore size of about 100 nm to about 800 nm, wherein the membrane substrate is characterised by a crystallinity of about 10% to about 70% relative to an uncarbonised porous polymer; and
ii) a COF layer interfacially polymerised on a surface of the membrane substrate, the COF layer formed from amino monomeric units and acyl monomeric units; wherein the COF layer has a pore size of about 0.5 nm to about 10 nm.

In some embodiments, the COF layer has a pore size of about 0.8 nm to about 2.4 nm.

In some embodiments, the COF layer has a thickness of about 50 nm to about 500 nm, or preferably about 100 nm.

In some embodiments, the COF layer is characterised by an X-ray diffraction (XRD) 2θ value of about 3° to about 8°.

In some embodiments, the COF membrane is characterised by a dye rejection of more than about 90%.

In some embodiments, when the amino monomeric unit is HZ, the COF membrane is characterised by a Evans blue rejection of more than about 99.5%.

In some embodiments, when the amino monomeric unit is HZ, the COF membrane is characterised by a methyl blue rejection of more than about 99.5%.

In some embodiments, when the amino monomeric unit is HZ, the COF membrane is characterised by a fuchsin acid rejection of more than about 95%.

In some embodiments, when the amino monomeric unit is HZ, the COF membrane is characterised by a methyl orange rejection of more than about 91%.

In some embodiments, when the amino monomeric unit is HZ, the COF membrane is characterised by a water permeance of about 50 L m⁻² h⁻¹ bar⁻¹ to about 800 L m⁻² h⁻¹ bar⁻¹, or preferably about 150 L m⁻² h⁻¹ bar⁻¹.

In some embodiments, when the amino monomeric unit is DHBD, the COF membrane is characterised by a water permeance of about 200 L m⁻² h⁻¹ bar⁻¹ to about 800 L m⁻² h⁻¹ bar⁻¹, or preferably about 320 L m⁻² h⁻¹ bar⁻¹.

In some embodiments, the COF membrane is characterised by a polar aprotic solvent permeance of about 10 L m⁻² h⁻¹ bar⁻¹ to about 100 L m⁻² h⁻¹ bar⁻¹, or preferably about 50 L m⁻² h⁻¹ bar⁻¹.

In some embodiments, the COF membrane is characterised by a NMP permeance of 20 L m⁻² h⁻¹ bar⁻¹ to about 100 L m⁻² h⁻¹ bar⁻¹.

In some embodiments, the COF membrane is characterised by a DMSO permeance of 20 L m⁻² h⁻¹ bar⁻¹ to about 100 L m⁻² h⁻¹ bar⁻¹.

In some embodiments, the COF membrane is stable against organic solvents for at least 60 days.

In some embodiments, the organic solvent is selected from DMF, NMP, DMSO, or a combination thereof.

In some embodiment, COF membrane is formed as a flat sheet or a hollow fiber.

In some embodiments, the membrane substrate is an organic membrane substrate.

In some embodiments, the membrane substrate has a pore size of about 100 nm to about 300 nm.

In some embodiments, the at least partially carbonised porous polymer is about 40% to about 70% carbonised.

In some embodiments, the membrane substrate is characterised by a molecular weight cut-off (MWCO) of about 500 kDa to about 4000 kDa.

The present invention also provides a COF membrane for use in separating a catalyst from an organic solvent.

In some embodiments, the COF membrane is characterised by a Pd(PPh₃)₄ rejection of more than about 95%.

The present invention also provides a method of recovering a compound from a solution, comprising nanofiltering the solution through the COF membrane as disclosed herein in order to form a retentate and a permeate, wherein the compound is retained in the retentate.

In some embodiments, a size of the compound is at least about 60% relative to a pore size of the COF membrane.

In some embodiments, the size of the compound is at least about 90% relative to a pore size of the COF membrane.

In some embodiments, the COF membrane is characterised by a MWCO of about 300 Da to about 5000 Da.

In some embodiments, the nanofiltration is performed under a pressure of about 2 bar.

In some embodiments, the nanofiltration is performed under an inert atmosphere. In some embodiments, the nanofiltration is performed under an argon atmosphere.

In some embodiments, the compound is an organometallic compound and/or an organic compound having a molecular weight of at least 600 Da.

In some embodiments, the method is characterised by a compound recovery yield of at least 90%.

In some embodiments, the method is characterised by a compound recovery of at least 1 g.

In some embodiments, the method further comprises purifying the compound in the retentate.

In some embodiments, when the compound is a catalyst, the recovered catalyst is reusable in another catalytic cycle.

In some embodiments, when the recovered catalyst is reused in another catalytic cycle, the catalytic yield is substantially similar to a catalytic cycle using fresh catalyst.

In some embodiments, the recovered catalyst is reusable in at least 10 catalytic cycles.

In some embodiments, the method further comprises recovering a second compound from the permeate, comprising nanofiltering the permeate through a second COF membrane as disclosed herein in order to form a second retentate and a second permeate, wherein the second compound is retained in the second retentate; and wherein the second COF membrane has a smaller pore size relative to the first COF membrane.

### BRIEF DESCRIPTION OF DRAWINGS

Embodiments of the present invention will now be described, by way of non-limiting example, with reference to the drawings in which:

FIG. 1 shows (a) optical images of the carbonised PAN substrates; (b) cross-sectional and (c) surface FESEM images of the carbonised PAN substrates.

FIG. 2 shows (a) pure solvent permeance as a function of their inverse viscosity for C-PAN substrates, with the dashed line indicating a hypothetical linear relationship; (b) rejection of the C-PAN substrates for polyethylene oxide (PEO) with different molecular weight and (c) rejection as a function of In dₛ.

FIG. 3 shows (a) swelling degree of the C-PAN substrates in six different organic solvents; and (b) long-term solvent permeance of the C-PAN substrates in aggressive organic solvents.

FIG. 4 shows (a) stress-strain curves of the PAN and C-PAN substrates; and (b) Young's modulus and tensile strength of PAN and C-PAN substrates.

FIG. 5 shows XRD patterns of original non-carbonised PAN and carbonised PAN substrates formed at different temperatures.

FIG. 6 shows (a) chemical structures of the COFs used for synthesizing the COF membranes via interfacial polymerization; and (b) PXRD patterns of the COF membranes.

FIG. 7 shows (a) cross-sectional FESEM image of the Tp-PDA membrane; (b) and (c) surface FESEM images of the Tp-PDA membrane.

FIG. 8 shows (a) filtration performance of the COF membranes with different pore sizes for dye rejection in water; (b) UV-vis absorption spectra of Evans blue in feed and permeate; and (c) photograph of feed (100 ppm of Evans blue) and filtrate.

FIG. 9 shows (a) pure solvent permeance as a function of their inverse viscosity for Tp-DHBD membrane, with the dashed line indicating a hypothetical linear relationship;

(b) long-term test of DMF permeance and dye rejection for Tp-DHBD membrane; and (c) catalyst recovery performance of the COF membranes in organic solvent nanofiltration.

FIG. 10 shows water permeance and dye rejection of the (a) COF@C-PAN and (b) COF@NC-PAN membranes.

FIG. 11 shows (a) nanofiltration performance of the COF membrane for rejecting methyl blue (MB) in water and DMF. (b) Nanofiltration performance of commercial polymeric membranes, state-of-the-art membranes and the COF membrane for dye rejection in DMF. (c) Ultraviolet-visible absorption spectra of the Pd(PPh₃)₄ catalyst in feed and permeate. (d) Nanofiltration performance of the COF membranes for rejecting Pd(PPh₃)₄ in DMF and N-methyl-2-pyrrolidone (NMP). (e) Ultraviolet-visible absorption spectra of the Ir[(dtbbpy)(ppy)₂]PF₆ catalyst in feed and permeate. (f) Catalyst recovery and permeance of the COF membranes for Ir[(dtbbpy)(ppy)₂]PF₆ recovery in N,N-dimethylacetamide (DMA) during 5 cycles of measurements.

FIG. 12 shows preparation and characterization of solvent-resistant COF membranes. (A) The preparation procedure of carbonized PAN substrates. (B) Cross-sectional and (C) Surface FESEM images of carbonized PAN substrates. (D) Volume and weight swelling properties of carbonized PAN substrates in different organic solvents. (E) Long-term organic solvent permeation test of carbonized PAN substrates. (F) Preparation procedures and (G) chemical structures of COF membranes. (H) Surface FESEM image (inserted with an optical image, and the ruler has a scale up to 15 cm) and (I) Cross-sectional FESEM image of COF Tp-TAPB membrane. (J) Cross-sectional TEM image of COF Tp-TAPB membrane. (K) High-resolution TEM image of COF-Tp-TAPB membrane (inserted with a selected area electron diffraction image (upper right) and a crystal structure image of Tp-TAPB showing the (001) plane (lower left)).

FIG. 13 shows the weight swelling in DMF and DMF permeance of the carbonized PAN substrates prepared under different carbonization temperatures.

FIG. 14 shows (a) Dye rejection performance of the COF membranes. (b) UV-Vis absorption spectra of Evans blue in feed and permeate. (c) Photo of feed (left, 100 ppm of Evans blue) and filtrate (right).

FIG. 15 shows separation performance of COF membranes. (A) Three-dimensional size of [Ir-1]PF6, [Ir-2]PF6, [Ir-3]PF6, [Ru](PF6)2, NaDT, and (R)-TRIP photocatalysts involved in this study. (B) Separation performance of the customizable COF membranes for the recovery of specific photocatalysts. Error bars represent standard deviations for 3 measurements.

FIG. 16 shows catalyst recovery performance of different homogeneous photocatalysis reactions using COF membranes. (A) Aryl amination via metallaphotoredox (solvent: DMA). (B) Intermolecular cycloaddition via EnT (solvent: HFIP), (C) Intramolecular cycloaddition via EnT (solvent: DCM). (D) Alkylation of heteroarenes via SET (solvent: MeOH/DMSO). (E) Aromatic C—H thiolation via SET (solvent: MeCN). (F) Enantioselective Minisci-type addition via SET (solvent: 1,4-dioxane).

FIG. 17 shows schematic illustration of (A) 2 g-scale photocatalyst recovery and (B) stepwise separation of photocatalysts and products (NFSI=N-fluorobenzenesulfonimide, P=product, S=starting material, and PC=photocatalyst).

### DETAILED DESCRIPTION

The inventors have found that by using the pore-forming agents to control the pore size of the polymer substrates and carbonising the polymer in the presence of the pore-forming agents at a suitable temperature, the resultant substrate can have an improved (or at least acceptable) mechanical strength. These carbonised membrane substrates are suitable for use in permeation of aggressive organic solvents. This allows for the preparation and scale-up of highly permeable and robust porous substrates for industrial liquid separations, especially those involving aggressive organic solvents. The high flux of the substrates can effectively improve productivity in practical applications, such as nanofiltration. The membrane substrates are suitably stable in polar protic solvents, nonpolar aprotic solvents as well as polar aprotic solvents. The swelling degrees of the membrane substrates in aggressive organic solvents are very low, which makes them ideal substrates/separators in practical applications involving organics, such as organic solvent nanofiltration and flow battery. The membrane substrates can have a desirable Young's modulus (for example, about 640 MPa) and tensile strength (for example, about 13 MPa). The high mechanical strength can prevent premature fracture during the long-term operations in industry.

In contrast, earlier studies was carried out at a very high temperature and which resulted in a membrane substrate with poor mechanical properties (e.g. brittle).

Further, by interfacially polymerising a COF membrane on a surface of the membrane substrate, the problems of poor chemical stability and low porosity in conventional polymeric membranes can be overcome. The COF membrane is also less prone to delaminate from the membrane substrate. In addition, the pore sizes of the COF membranes can be readily adjusted to meet the different separation requirements in industry.

Unless defined otherwise, all technical and scientific terms used herein have the same meaning as commonly understood by those of ordinary skill in the art to which the invention belongs. Although any methods and materials similar or equivalent to those described herein can be used in the practice or testing of the present invention, preferred methods and materials are described. For the purposes of the present invention, the following terms are defined below.

As used herein, “polyacrylonitrile” or “PAN” is a vinyl polymer, and a derivative of the acrylate family of polymers. It is made from the monomer acrylonitrile and can be polymerised by free radical vinyl polymerization. PAN is a synthetic, semicrystalline organic polymer, with the linear formula (C₃H₃N)ₙ. Though it is thermoplastic, it does not melt under normal conditions. It degrades before melting. More commonly used are PAN copolymers made from mixtures of other monomers with acrylonitrile as the main monomer. For example, monomers of vinyl chloride, styrene and/or butadiene can be added to acrylonitrile to form PAN copolymers. Accordingly, PAN homopolymer and PAN copolymers are within the scope of PAN as used herein to describe the present invention. In particular, PAN homopolymer, having a weight-average molecular weight Mw 30,000 to 250,000; copolymer PAN-methyl acrylate, PAN-methyl methacrylate may be used.

The term “pore-forming agent” as used herein refers to an additive which can be added to the porous polymer in order to alter the polymer's permeation property. In general, the pore-forming agent turns into a fluid with low viscosity when melted at elevated temperatures. In use, the pore-forming agent acts to increase the pore size of the porous polymer due to the volume expansion when it changes its phase during the carbonisation step. For example, the pore-forming agent may decompose at a high temperature to release a volatile gas. The escaping gas may push against the walls of the pores to increase the pore size.

The term “membrane” as used herein refers to a polymeric material which is porous, for use in an application that utilises this property. Such membranes are usually permeable to certain selective entities when subjected to, for example, a pressure and/or concentration gradient. Such membranes can be used in membrane technology, which relies on physical forces (and optionally without heat or at cold conditions) to separating gases or liquids from a mixture. The skilled person would be aware that the selection of polymeric membrane is not trivial and has to have appropriate characteristics for the intended application. For example, in the case of biotechnology applications, the polymeric membrane has to offer a low binding affinity for separated molecules. In the case of waste water treatment, the membrane has to withstand the harsh conditions. In this regard, the polymeric membrane can for example be assessed in terms of its chains rigidity, chain interactions, stereo-regularity, and polarity of its functional groups.

“Carbonisation” refers to the conversion of organic matters into carbon through destructive distillation, a chemical process in which decomposition of organic material is achieved by heating it to a high temperature. Carbonisation is a pyrolytic reaction, and is a complex process in which many reactions take place concurrently such as dehydrogenation, condensation, hydrogen transfer and isomerization.

The present invention provides a method of forming a covalent organic framework (COF) membrane, comprising:
i) forming a membrane substrate by:
   a) impregnating a porous polymer with a pore-forming agent in order to form an impregnated polymer;
   b) at least partially carbonising the impregnated polymer at a temperature of about 150° C. to about 500° C. in order to form the membrane substrate;
   wherein the membrane substrate is characterised by a crystallinity of about 10% to about 70% relative to the porous polymer; and
ii) interfacially polymerising amino monomers and acyl monomers on a surface of the membrane substrate in order to form the COF membrane.

The pore-forming agents can be adsorbed into pores and cavities in the solid polymer during the impregnation step. During partial carbonisation, the pore-forming agent within the pores and cavities of the polymer evaporates and escapes from the polymer, and in the process expands the pores of the polymer, and optionally the pore necks. The carbonisation process is stopped before completion to retain some mechanical strength of the original porous polymer and prevent the material from becoming too brittle. The carbonisation of the impregnated polymer leads to their structural transition from linear polymeric chains into highly cross-linked network structures with low conformational flexibility, thus improves the solvent resistance. The membrane substrate also has a high flux for solvent permeation.

The impregnation step allows the pore-forming agent to enter the pores of the porous polymer. The initial pore size of the porous polymer can be about 10 nm to about 50 nm, or about 10 nm to about 30 nm. The porous polymer can for example be formed using electrospinning techniques, or via extrusion techniques to form a flat sheet or hollow fiber.

In some embodiments, the pore-forming agent is selected from a metal salt. In some embodiments, the pore-forming agent is selected from an inorganic metal salt. The interaction between the cation and the anion determines the stability at high temperature and its suitability for use as a pore forming agent. The metal salt should ideally be stable up to the carbonation temperature and then decompose to generate gas for expanding the pore size. The pore-forming agent is preferentially highly absorbed into the pores of the polymer. Additionally, after the carbonisation step, the residue salts can be easily washed out from the porous material. In some embodiments, the pore-forming agent is selected from calcium nitrate, calcium nitrite, calcium chloride, magnesium nitrate, magnesium nitrite, magnesium chloride, sodium nitrate, sodium nitrite, sodium carbonate, potassium carbonate, aluminium nitrate, aluminium nitrite, zinc nitrate, ferric nitrate, ferrous nitrate, cupric nitrate, calcium acetate, tetrabutylammonium bromide, sodium pyridine acetate or a combination thereof. In some embodiments, the pore-forming agent is selected from calcium nitrate, calcium nitrite, calcium chloride, magnesium nitrate, magnesium nitrite, magnesium chloride, sodium nitrate, sodium nitrite, sodium carbonate, potassium carbonate, aluminium nitrate, aluminium nitrite or a combination thereof.

In other embodiments, the pore-forming agent is an organic salt. For example, calcium acetate, tetrabutylammonium bromide, sodium pyridine acetate or a combination thereof can be used.

In some embodiments, the pore-forming agent is provided in an aqueous medium at a concentration of about 0.1 M to about 10 M. In other embodiments, the concentration is about 0.1 M to about 9 M, about 0.1 M to about 8 M, about 0.1 M to about 7 M, about 0.1 M to about 6 M, about 0.1 M to about 5 M, about 0.1 M to about 4 M, about 0.1 M to about 3 M, about 0.1 M to about 2 M, or about 0.1 M to about 1 M. In some embodiments, the pore-forming agent is provided in an aqueous medium at a concentration of about 0.5 M.

In some embodiments, a weight ratio of porous polymer to pore-forming agent is about 0.1 to about 0.4. In other embodiments, the weight ratio is about 0.1 to about 0.3 or 0.1 to about 0.2.

In some embodiments, the porous polymer is a porous polymer sheet. The porous polymer sheet can be a film or a layer of polymer. In other embodiments, the porous polymer is a hollow fiber. The skilled person would understand that ‘hollow fiber’ refers to a tube like structure.

In some embodiments, the porous polymer is selected from polyacrylonitrile (PAN), polyethersulfone (PES), polyvinylidene fluoride (PVDF), polysulfone, sodium alginate, chitosan, polydimethylsiloxane, polyvinyl alcohol, poly (ether-ether-ketone), poly (methyl methacrylate) (PMMA), polytetrafluoroethylene (PTFE) or a combination or co-polymer thereof.

In an embodiment, when the porous polymer is a PAN, the PAN polymer is a PAN homopolymer. The PAN polymer can have a weight-average molecular weight (Mw) of about 200,000 g mol⁻¹. In another embodiment, the PAN polymer is selected from a PAN homopolymer having a weight-average molecular weight (Mw) of about 30,000 to about 250,000 g mol⁻¹, copolymer PAN-methyl acrylate, PAN-methyl methacrylate and a combination thereof. In another embodiment, the PAN polymer is selected from a PAN homopolymer having a weight-average molecular weight Mw of about 30,000 to about 250,000 g mol⁻¹, copolymer PAN-methyl acrylate and PAN-methyl methacrylate.

In some embodiments, the porous polymer comprises a polymer additive. The polymer additive is a substance that is added to a polymer to modify its properties. Such substance is usually added at a lower weight percentage than the polymer itself, and can be any kind or molecular, polymeric, inorganic or organic substance. For example, plasticizers can be used to lower the glass transition temperature of the polymer, fillers can be used to make it cheaper, and oily components can be used to improve its rheology. Polymer additives can also be added to the porous polymer to adjust the microstructure and pore size of the polymer. Examples of polymer additives are plasticizers (to improve rheology as well as elasticity), anti-aging stabilizers or anti-oxidants (to reduce brittleness, discoloration, and loss of some physical properties), blowing agents (to form a cellular structure within the polymer and reduces density and improves insulation properties), flame retardants (to prevent, delay, or slow down combustion), nucleating agents (to improve mechanical properties, transparency, speed up plastic crystallization rate, reducing overall cycle time), processing additives (to improve the processability and processing characteristics of the polymer), anti-static additives (to minimize the potential for static electricity build up on the surface of the plastic), colorants, odour agent and anti-microbial agent.

An example of a plasticiser is phthalate esters. Examples of anti-oxidants are phenols, aryl amines, and phosphates. Examples of UV stabilizers include benzophenones and benzotriazoles, and carbon black. Examples of flame retardants are halogens such as bromines, phosphorus and nitrogen compounds. Examples of processing additives include lubricants, fatty acids, hydrocarbon waxes, and polyethylene. Examples of anti-static additives include amines, ammonium compounds, and polyethylene glycol esters.

In an embodiment, the polymer additive is selected from polyvinylpyrrolidone (PVP), polyethylene oxide (PEO) and polyvinyl alcohol (PVA).

In an embodiment, the porous polymer comprises a polymer additive at about 5 wt % to about 30 wt % relative to the porous polymer. In another embodiment, the polymer additive is about 10 wt % to about 30 wt %; about 10 wt % to about 25 wt %; about 14 wt % to about 25 wt %; about 14 wt % to about 20 wt %; or about 15 wt % to about 20 wt %. In another embodiment, the polymer additive is about 12 wt %; about 13 wt %; about 14 wt %; about 15 wt %; about 16 wt %; about 17 wt %; about 18 wt %; about 19 wt %; about 20 wt %; about 21 wt %; about 22 wt %; or about 23 wt %.

In some embodiments, the impregnation step is performed for at least about 1 h. In other embodiments, the duration is at least about 2 h, about 3 h, about 4 h, about 5 h, about 6 h, about 8 h, about 10 h, about 12 h, about 24 h, about 48 h. In some embodiments, the impregnation step is performed for about 24 h.

In some embodiments, the method further comprises a step of drying the impregnated polymer after the impregnation step. The impregnated polymer can be dried by placing it in an oven at about 40° C. to about 90° C., or subjecting the impregnated polymer to a vacuum. Alternatively, the impregnated polymer can be freeze dried.

In some embodiments, the impregnated polymer and/or the porous polymer is at least about 20% carbonised. The degree of carbonisation can be monitored using, for example, X-ray diffraction (XRD) by observing the change in peak intensity. For example, when the polymer is PAN, the degree of carbonisation can be monitored by tracking the loss of intensity for a given peak. In other embodiments, the degree of carbonisation is at least about 30%, about 40%, about 50%, about 60%, about 70%, about 80%, or about 90%.

In some embodiments, the porous material is characterised by a degree of carbonisation relative to the porous polymer of at least about 20%, about 30%, about 40%, about 50%, about 60%, about 70%, about 80%, or about 90%.

In some embodiments, the membrane substrate is characterised by a crystallinity of about 10% to about 70% relative to the porous polymer. In this regard, the membrane substrate has less crystallinity than the original porous polymer. In other embodiments, the crystallinity is about 20% to about 70%, about 30% to about 70%, about 30% to about 60%, or about 40% to about 60%.

In some embodiments, the carbonisation step is performed at a temperature of about 150° C. to about 500° C. In other embodiments, the temperature is about 150° C. to about 450° C., about 150° C. to about 400° C., about 150° C. to about 350° C., about 150° C. to about 300° C., about 150° C. to about 250° C., or about 200° C. to about 500° C. In some embodiments, the impregnated polymer is carbonised at a temperature of about 200° C., or about 210° C.

In some embodiments, the carbonisation step is performed with a ramp rate of about 1° C. min⁻¹ to about 10° C. min⁻¹. In other embodiments, the ramp rate is about 1° C. min⁻¹ to about 9° C. min⁻¹, about 1° C. min⁻¹ to about 8° C. min⁻¹, about 1° C. min⁻¹ to about 7° C. min⁻¹, about 1° C. min⁻¹ to about 6° C. min⁻¹, about 1° C. min⁻¹ to about 5° C. min⁻¹, about 1° C. min⁻¹ to about 4° C. min⁻¹, about 1° C. min⁻¹ to about 3° C. min⁻¹, or about 1° C. min⁻¹ to about 2° C. min⁻¹. In some embodiments, the carbonisation step is performed with a ramp rate of about 2° C. min⁻¹.

In some embodiments, the impregnated polymer is carbonised for about 30 min to about 360 min. In other embodiments, the duration is about 30 min to about 340 min, about 30 min to about 320 min, about 30 min to about 300 min, about 30 min to about 280 min, about 30 min to about 260 min, about 30 min to about 240 min, about 30 min to about 220 min, about 30 min to about 200 min, about 30 min to about 180 min, about 30 min to about 160 min, about 30 min to about 140 min, about 30 min to about 120 min, about 30 min to about 100 min, about 40 min to about 100 min, about 50 min to about 100 min, about 60 min to about 100 min, about 70 min to about 100 min, or about 80 min to about 100 min. In some embodiments, the impregnated polymer is carbonised for about 90 min.

In some embodiments, the impregnated polymer is carbonised in the presence of oxygen. In other embodiments, the impregnated polymer is carbonised in ambient conditions. Ambient conditions refer to conditions relating to the immediate surroundings. This can relate to conditions having a temperature of about 5° C. to about 40° C., a relative humidity of about 10% to about 90%, pressure of about 1 atm and/or oxygen at about 21%. When used in conjunction with a specified temperature range, ambient conditions refer to a relative humidity of about 10% to about 90%, pressure of about 1 atm and/or oxygen at about 21%.

In some embodiments, the method further comprises a step of washing the membrane substrate. In some embodiments, the membrane substrate is washed with water and/or ethanol.

After performing the method as disclosed herein, the initial porosity of the porous polymer is altered. For example, when the method is performed on PAN polymer with a pore size of about 10 nm, the pore size of the final membrane substrate is about 50 nm to about 500 nm, or about 100 nm to about 500 nm. In some embodiments, a change in pore size is an increase of about 5 times to about 100 times. In other embodiments, the change in pore size is an increase of about 10 times to about 90 times, about 10 times to about 80 times, about 10 times to about 70 times, about 10 times to about 60 times, or about 10 times to about 50 times.

Alternatively, the change in the initial porous polymer to the final membrane substrate can be characterised by the change in MWCO. For example, when PAN polymer having a MWCO of about 100,000 is used, the final membrane substrate has a MWCO of about 1500,000. In some embodiments, a change in MWCO is an increase of about 10 times to about 100 times. In other embodiments, the change in MWCO is an increase of about times to about 100 times, about 30 times to about 100 times, about 40 times to about 100 times, about 50 times to about 100 times, about 60 times to about 100 times, about 60 times to about 90 times, about 60 times to about 80 times, or about 60 times to about 70 times.

By varying the amino monomers and/or the acyl monomers, the pore size of the COF membrane can readily be adjusted to meet the different separation requirements in industry. The COF membranes have well-defined pore channels which provide high fluxes for solvents. The COF membranes are stable in polar protic solvents, nonpolar aprotic solvents as well as polar aprotic solvents for up to 60 days. This allows these COF membranes to be used in practical applications involving aggressive organic solvents.

In some embodiments, the amino monomer comprises at least two amino moieties. In other embodiments, the amino monomer comprises at least three amino moieties. In other embodiments, the amino monomer comprises two to five amino moieties, or two to four amino moieties, or two to three amino moieties.

In some embodiments, the amino monomer is an amine. In other embodiments, the amino monomer is selected from p-phenylenediamine (PDA), hydrazine hydrate (HZ), 1,3,5-tris (4-aminophenyl)benzene (TAPB), 3,3-dihydroxybenzidine (DHBD), 2,2′-bipyridine-5,5′-diamine, 4,4′-azodianiline, 4,4′,4″-(1,3,5-triazine-2,4,6-triyl)trianiline, 4,4′,4″-(1,3,5-triazine-2,4,6-triyl) tris (1,1′-biphenyl)trianiline, benzidine, 2,5-diethoxy-terephthalohydrazide, 2,5-diaminebenzene-1,4-disulfonic acid, 2,5-diaminebenzenesulfonic acid, triphenylene hexamine, 1,4-phenylenediamine, melamine, 2,5-dimethylbenzene-1,4-diamine or a combination thereof.

In some embodiments, the acyl monomer is an aldehyde monomer. Accordingly, the method of forming a covalent organic framework (COF) membrane comprises:
i) forming a membrane substrate by:
   a) impregnating a porous polymer with a pore-forming agent in order to form an impregnated polymer;
   b) at least partially carbonising the impregnated polymer at a temperature of about 150° C. to about 500° C. in order to form the membrane substrate;
   wherein the membrane substrate is characterised by a crystallinity of about 10% to about 70% relative to the porous polymer; and
ii) interfacially polymerising amino monomers and acyl monomers on a surface of the membrane substrate in order to form the COF membrane;
wherein the acyl monomers are aldehyde monomers.

In some embodiments, the acyl monomer comprises at least two acyl moieties. In other embodiments, the acyl monomer comprises at least three acyl moieties. In other embodiments, the acyl monomer comprises two to five acyl moieties, or two to four acyl moieties, or two to three acyl moieties. As mentioned, the acyl moieties may be aldehyde moieties.

In some embodiments, the aldehyde is selected from 1,3,5-triformylphloroglucinol, 1,3,5-triformylbenzene, terephthalaldehyde, 4,4′-biphenyldicarboxaldehyde, 2,5-bis (2-propynyloxy)terephthalaldehyde, 2,5-dimethoxyterephthalaldehyde, 4,4′-biphenyldialdehyde, tetrathiafulvalene-tetrabenzaldehyde or a combination thereof.

The amino and acyl can react with each other to form an imine (—C═N—) moiety.

In some embodiments, the interfacial polymerisation comprises:
a) homogenously coating the surface of the membrane substrate with amino monomers in order to form a surface coated with amino monomers; and
b) homogenously coating the surface coated with amino monomers with acyl monomers; and
c) polymerising the amino monomers to the acyl monomers.

Interfacial polymerization is a type of step-growth polymerization in which polymerization occurs at the interface between two immiscible phases, resulting in a polymer that is constrained to the interface. In the present invention, the interface is the surface of the membrane substrate which is in contact with the liquid monomers. This results in the polymer being attached to the surface of the membrane substrate. Forming the COF layer on the support by interfacial polymerisation was found to provide a stable membrane which is resistant to delamination by solvent and with a controllable and consistent porosity throughout the membrane.

In this method, the amino monomers is first allowed to saturate the surface of the membrane substrate. The acyl monomers is then added and allowed to saturate the surface before polymerisation occurs. The polymerisation reaction cross links the amino monomers with the acyl monomers to form a COF layer. Alternatively, the acyl monomers can be added to the surface first, and subsequently the amino monomers.

In some embodiments, the amino monomers is provided in an aqueous medium.

The term ‘aqueous medium’ used herein refers to a water based solvent or solvent system, and which comprises of mainly water. Such solvents can be either polar or non-polar, and/or either protic or aprotic. Solvent systems refer to combinations of solvents which resulting in a final single phase. Both ‘solvents’ and ‘solvent systems’ can include, and is not limited to, pentane, cyclopentane, hexane, cyclohexane, benzene, toluene, dioxane, chloroform, diethylether, dichloromethane, tetrahydrofuran, ethyl acetate, acetone, dimethylformamide, acetonitrile, dimethyl sulfoxide, nitromethane, propylene carbonate, formic acid, butanol, isopropanol, propanol, ethanol, methanol, acetic acid, ethylene glycol, diethylene glycol or water. Water based solvent or solvent systems can also include dissolved ions, salts and molecules such as amino acids, proteins, sugars and phospholipids. Such salts may be, but not limited to, sodium chloride, potassium chloride, ammonium acetate, magnesium acetate, magnesium chloride, magnesium sulfate, potassium acetate, potassium chloride, sodium acetate, sodium citrate, zinc chloride, HEPES sodium, calcium chloride, ferric nitrate, sodium bicarbonate, potassium phosphate and sodium phosphate. As such, biological fluids, physiological solutions and culture medium also falls within this definition.

In some embodiments, the amino monomers is at a concentration of about 0.1 mM to about 10 mM. In other embodiments, the concentration is about 0.1 mM to about 9 mM, about 0.1 mM to about 8 mM, about 0.1 mM to about 7 mM, about 0.1 mM to about 6 mM, about 0.1 mM to about 5 mM, about 0.1 mM to about 4 mM, about 0.1 mM to about 3 mM, about 0.1 mM to about 2 mM, about 0.5 mM to about 2 mM, or about 1 mM to about 2 mM. In some embodiments, the amino monomers is at a concentration of about 1.2 mM.

In some embodiments, the aqueous medium further comprises a catalyst such as p-toluene sulfonic acid. p-Toluene sulfonic acid acts as a catalyst for synthesising COFs. Other catalysts may also be used, such as, acetic acid, n-hexanoic acid, n-octanoic acid, n-decylic acid, 4-hydroxybenzenesulfonic acid hydrate, n-hexanoic acid, enanthic acid, and scandium (III) trifluoromethanesulfonate (Sc (OTf)₃) or a combination thereof. In some embodiments, catalyst is at a concentration of about 0.1 mM to about 10 mM. In other embodiments, the concentration is about 0.1 mM to about 9 mM, about 0.1 mM to about 8 mM, about 0.1 mM to about 7 mM, about 0.1 mM to about 6 mM, about 0.1 mM to about 5 mM, about 0.1 mM to about 4 mM, about 0.1 mM to about 3 mM, about 0.1 mM to about 2 mM, about 0.5 mM to about 2 mM, or about 1 mM to about 2 mM.

In some embodiments, the step of coating with amino monomers is performed for at least about 1 min. This allows the amino monomers to at least partially penetrate the membrane substrate. In other embodiments, the duration is for at least about 2 min, about 3 min, about 4 min, about 5 min, about 6 min, about 7 min, about 8 min, about 9 min, about 10 min, about 20 min, about 30 min, about 40 min, about 50 min, or about 60 min.

In some embodiments, the acyl monomers is provided in an organic medium.

“Organic medium” refers to a carbon based solvent or solvent system. Such solvents can be either polar or non-polar, and/or either protic or aprotic. Solvent systems refer to combinations of solvents which resulting in a final single phase. Both ‘solvents’ and ‘solvent systems’ can include, and is not limited to, mesitylene, pentane, cyclopentane, hexane, cyclohexane, benzene, toluene, dioxane, chloroform, diethylether, dichloromethane, tetrahydrofuran, ethyl acetate, acetone, dimethylformamide, acetonitrile, dimethyl sulfoxide, nitromethane, propylene carbonate, formic acid, butanol, isopropanol, propanol, ethanol, methanol, acetic acid, ethylene glycol, diethylene glycol or water. Organic based solvents or solvent systems can include, but not limited to, any non-polar liquid which can be hydrophobic and/or lipophilic. As such, oils such as animal oil, vegetable oil, petrochemical oil, and other synthetic oils are also included within this definition.

In some embodiments, the organic medium is mesitylene. It was found that mesitylene can help form COFs with a good crystallinity. Additionally, acyl monomers such as Tp has high solubility in mesitylene.

In some embodiments, the acyl monomers is at a concentration of about 0.1 mM to about 10 mM. In other embodiments, the concentration is about 0.1 mM to about 9 mM, about 0.1 mM to about 8 mM, about 0.1 mM to about 7 mM, about 0.1 mM to about 6 mM, about 0.1 mM to about 5 mM, about 0.1 mM to about 4 mM, about 0.1 mM to about 3 mM, about 0.1 mM to about 2 mM, about 0.5 mM to about 2 mM, or about 1 mM to about 2 mM. In some embodiments, the acyl monomers is at a concentration of about 0.9 mM.

In some embodiments, the step of coating with acyl monomers is performed for at least 1 min. This allows the acyl monomers to at least partially penetrate the membrane substrate and the amino monomer layer. In other embodiments, the duration is for at least about 2 min, about 3 min, about 4 min, about 5 min, about 6 min, about 7 min, about 8 min, about 9 min, about 10 min, about 20 min, about 30 min, about 40 min, about 50 min, or about 60 min. In some embodiments, the step of coating with acyl monomers is performed for at least 5 min.

In some embodiments, the polymerisation is performed in the presence of an acid. The acid can be an organic acid or inorganic acid. In some embodiments, the acid is acetic acid. Acetic acid is a catalyst for forming COFs.

In some embodiments, the acid is at a concentration about 0.1 mM to about 10 mM. In other embodiments, the concentration is about 0.1 mM to about 9 mM, about 0.1 mM to about 8 mM, about 0.1 mM to about 7 mM, about 0.1 mM to about 6 mM, about 0.1 mM to about 5 mM, about 0.1 mM to about 4 mM, about 0.1 mM to about 3 mM, about 0.5 mM to about 3 mM, about 1 mM to about 3 mM, or about 2 mM to about 3 mM. In some embodiments, the acid is at a concentration about 2.5 mM.

In some embodiments, the polymerisation is performed at a temperature of about 40° C. to about 90° C. In other embodiments, the temperature is about 40° C. to about 80° C., about 40° C. to about 70° C., about 50° C. to about 70° C., about 55° C. to about 70° C., or about 55° C. to about 65° C. In some embodiments, the polymerisation is performed at a temperature of about 60° C.

In some embodiments, the polymerisation is performed for about 2 h to about 60 h. In other embodiments, the duration is about 2 h to about 50 h, about 2 h to about 40 h, about 4 h to about 40 h, about 6 h to about 40 h, about 8 h to about 40 h, about 10 h to about 40 h, about 12 h to about 40 h, about 14 h to about 40 h, about 16 h to about 40 h, about 18 h to about 40 h, about 20 h to about 40 h, about 24 h to about 40 h, about 28 h to about 40 h, or about 32 h to about 40 h. In some embodiments, the polymerisation is performed for about 36 h.

In some embodiments, the method of forming a covalent organic framework (COF) membrane comprises:
i) forming a membrane substrate by:
   a) impregnating a porous polymer with a pore-forming agent in order to form an impregnated polymer;
   b) at least partially carbonising the impregnated polymer in the presence of oxygen and at a temperature of about 150° C. to about 500° C. in order to form the membrane substrate;
   wherein the membrane substrate is characterised by a crystallinity of about 10% to about 70% relative to the porous polymer; and
ii) interfacially polymerising amino monomers and acyl monomers on a surface of the membrane substrate in order to form the COF membrane;
wherein the acyl monomers are aldehyde monomers.

In some embodiments, the method of forming a covalent organic framework (COF) membrane comprises:
i) forming a membrane substrate by:
   a) impregnating a porous polymer with a pore-forming agent in order to form an impregnated polymer;
   b) at least partially carbonising the impregnated polymer in the presence of oxygen and at a temperature of about 150° C. to about 500° C. in order to form the membrane substrate;
   wherein the membrane substrate is characterised by a crystallinity of about 10% to about 70% relative to the porous polymer; and
ii) interfacially polymerising amino monomers and acyl monomers on a surface of the membrane substrate in order to form the COF membrane;
wherein the membrane substrate is characterised by a degree of carbonisation relative to the porous polymer of at least about 20%;
wherein the acyl monomers are aldehyde monomers.

In some embodiments, the method of forming a covalent organic framework (COF) membrane comprises:
i) forming a membrane substrate by:
   a) impregnating a porous polymer with a pore-forming agent in order to form an impregnated polymer;
   b) at least partially carbonising the impregnated polymer in the presence of oxygen and at a temperature of about 150° C. to about 500° C. in order to form the membrane substrate;
   wherein the membrane substrate is characterised by a crystallinity of about 10% to about 70% relative to the porous polymer; and
ii) interfacially polymerising amino monomers and acyl monomers on a surface of the membrane substrate in order to form the COF membrane;
wherein the acyl monomers are aldehyde monomers;
wherein the membrane substrate is characterised by a degree of carbonisation relative to the porous polymer of at least about 20%;
wherein the membrane substrate is characterised by an increase in pore size relative to the porous polymer of about 5 times to about 100 times.

The present invention also provides a covalent organic framework (COF) membrane, comprising:
i) a membrane substrate comprising an at least partially carbonised porous polymer, the membrane substrate having a pore size of about 100 nm to about 800 nm, wherein the membrane substrate is characterised by a crystallinity of about 10% to about 70% relative to an uncarbonised porous polymer; and
ii) a COF layer interfacially polymerised on a surface of the membrane substrate, the COF layer formed from amino monomeric units and acyl monomeric units;
wherein the COF layer has a pore size of about 0.5 nm to about 10 nm.

The uncarbonised porous polymer refers to the porous polymer in its initial state. In some embodiments, the at least partially carbonised porous polymer is characterised by a degree of carbonisation relative to the uncarbonised porous polymer of at least about 20%, about 30%, about 40%, about 50%, about 60%, about 70%, about 80%, or about 90%. In some embodiments, a degree of carbonisation of the at least partially carbonised porous polymer is characterised by an about 20% to about 90% decrease in X-ray diffraction (XRD) peak intensity relative to the uncarbonised porous polymer.

In some embodiments, the at least partially carbonised porous polymer is characterised by an increase in pore size relative to the uncarbonised porous polymer of about 5 times to about 100 times.

The membrane substrate of the present invention is an organic membrane substrate. As compared to an inorganic substrate, the organic substrate can show both high solvent resistance and mechanical strength. Besides, these substrates from carbonised polymers have good processability and can be easily scaled-up, which are beneficial for industrial applications. The cost of these polymeric substrates is also cheaper than commonly used inorganic substrates (e.g. ceramic substrates) in industrial.

In some embodiments, the membrane substrate has a pore size of about 100 nm to about 800 nm, about 100 nm to about 700 nm, about 100 nm to about 600 nm, about 100 nm to about 500 nm, about 100 nm to about 400 nm, or about 100 nm to about 300 nm.

In some embodiments, the at least partially carbonised porous polymer is about 20% to about 90% carbonised. In other embodiments, the at least partially carbonised porous polymer is about 30% to about 80% carbonised, about 30% to about 70%, about 40% to about 70%, about 40% to about 60%, or about 40% to about 50% carbonised.

In some embodiments, the membrane substrate has a thickness of about 100 μm to about 300 μm. In other embodiments, the thickness is about 120 μm to about 300 μm, about 140 μm to about 300 μm, about 160 μm to about 300 μm, about 180 μm to about 300 μm, about 200 μm to about 300 μm, about 220 μm to about 300 μm, about 240 μm to about 300 μm, about 260 μm to about 300 μm, or about 280 μm to about 300 μm.

The membrane substrate is able to reject organic solvents of various molecular weights (i.e. the solvent is prevented from passing through the substrate in one or both directions). The membrane substrate is also able to reject large molecules. Such molecules includes, but are not limited to, dyes and PEG. It should be noted that membrane substrate behave differently in different solvents and accordingly MWCO determined in one solvent need not coincide with that determined in another solvent. Further, the mathematical model used to determine the MWCO in the aqueous system is subject to its own set of assumptions that naturally leads to inaccuracies. Lastly, the shape of the solute molecules may also play a role in affecting its permeability across the membrane substrate. For example, PEG molecules are generally linear molecules and may slip through the membrane pores more easily compared to the more sterically bulky dyes. As such, dye molecules can be more easily rejected than PEG molecules of comparable molecular weights. Regardless, the use of these molecules provide an appropriate estimate of the molecular weight cut-off (MWCO) of the membrane substrate.

As used herein, “dye” is a substance that is soluble in the solvent it is in. It is used to impart colour by absorbing and/or re-emitting light of a certain wavelength. In this sense, coloured dyes absorb light in the visible wavelength and hence is observed as having a specific colour. Fluorescence dye or fluorophore absorbs light energy of a specific wavelength and re-emits light at a longer wavelength, usually in the visible range. Such are included within the scope of this definition.

The molecular weight cut off (MWCO) can be determined using a series of polyethylene oxide (PEO) or PEG dissolved in DI water. MWCO refers to the lowest molecular weight solute or molecule in which at least 80% (or preferably at least 90%) of the solute or molecule is retained by the membrane.

In some embodiments, the membrane substrate is characterised by a molecular weight cut-off (MWCO) of about 500 kDa to about 4000 kDa. In other embodiments, the MWCO is about 500 kDa to about 3500 kDa, about 500 kDa to about 3000 kDa, about 500 kDa to about 2500 kDa, about 500 kDa to about 2000 kDa, or about 1000 kDa to about 2000 kDa.

In some embodiments, the membrane substrate is characterised by a molecular weight cut-off (MWCO) of about 1500 kDa.

In some embodiments, the membrane substrate is characterised by a water permeance of 800 L m⁻² h⁻¹ bar⁻¹ to about 1100 L m⁻² h⁻¹ bar⁻¹.

In some embodiments, the membrane substrate is characterised by a DMF permeance of 1200 L m⁻² h⁻¹ bar⁻¹ to about 1600 L m⁻² h⁻¹ bar⁻¹.

In some embodiments, the membrane substrate is characterised by a n-hexane permeance of 2400 L m⁻² h⁻¹ bar⁻¹ to about 2800 L m⁻² h⁻¹ bar⁻¹.

In some embodiments, the membrane substrate is characterised by a NMP permeance of 100 L m⁻² h⁻¹ bar⁻¹ to about 160 L m⁻² h⁻¹ bar⁻¹.

In some embodiments, the membrane substrate is characterised by a DMSO permeance of 80 L m⁻² h⁻¹ bar⁻¹ to about 160 L m⁻² h⁻¹ bar⁻¹.

In some embodiments, the membrane substrate is characterised by a volume swelling of about 0.1% to about 10%. In other embodiments, the volume swelling is about 0.1% to about 9%, about 0.1% to about 8%, about 0.1% to about 7%, about 0.1% to about 6%, about 0.1% to about 5%, or about 0.1% to about 4%. In some embodiments, the membrane substrate is characterised by a volume swelling of about 0.1% to about 3.5%.

In some embodiments, the membrane substrate is characterised by a solvent uptake of about 0.1 to about 10%. In other embodiments, the solvent uptake is about 0.1% to about 9%, about 0.1% to about 8%, about 0.1% to about 7%, about 0.1% to about 6%, about 0.1% to about 5%, or about 0.1% to about 4%. In some embodiments, the membrane substrate is characterised by a solvent uptake of about 0.1 to about 3.5%.

In some embodiment, the membrane substrate is insoluble in solvents such as N-methylpyrrolidone and dimethylformamide. In another embodiment, the membrane substrate is insoluble in solvents such as acetone, ethyl acetate, hexane, tetrahydrofuran, chloroform, and alcohol solvents such as methanol, ethanol, propanol, isopropanol, 2-butanol, n-butanol, isobutanol, tert-butanol, 1-pentanol, 2-pentanol, 3-pentanol, 2-methylbutanol. In another embodiment, the membrane substrate is insoluble in solvents for at least two months.

In some embodiments, the membrane substrate is stable against organic solvents for at least 60 days. In some embodiments, the organic solvent is selected from DMF, NMP, DMSO, or a combination thereof.

In some embodiments, the membrane substrate is characterised by a tensile strength of about 10 MPa to about 20 MPa. In other embodiments, the tensile strength is about MPa to about 19 MPa, about 10 MPa to about 18 MPa, about 10 MPa to about 17 MPa, about 10 MPa to about 16 MPa, about 10 MPa to about 15 MPa, or about 10 MPa to about 14 MPa. In some embodiments, the membrane substrate is characterised by a tensile strength of about 13 MPa.

In some embodiments, the membrane substrate is characterised by a decrease in tensile strength relative to the uncarbonised porous polymer of about 10% to about 50%. In other embodiments, the decrease in tensile strength relative to the uncarbonised porous polymer is about 10% to about 45%, about 10% to about 40%, about 10% to about 35%, about 10% to about 30%, about 10% to about 25%, or about 15% to about 25%. In some embodiments, the membrane substrate is characterised by a decrease in tensile strength relative to the uncarbonised porous polymer of about 20%.

In some embodiments, the membrane substrate is characterised by a Young's modulus of about 500 MPa to about 900 MPa. In other embodiments, the Young's modulus is about 500 MPa to about 850 MPa, about 500 MPa to about 800 MPa, about 500 MPa to about 750 MPa, about 500 MPa to about 700 MPa, about 500 MPa to about 650 MPa, about 550 MPa to about 650 MPa, or about 600 MPa to about 650 MPa. In some embodiments, the membrane substrate is characterised by a Young's modulus of about 640 MPa.

In some embodiments, the membrane substrate is characterised by an increase in Young's modulus relative to the uncarbonised porous polymer of about 50% to about 200%. In other embodiments, the increase in Young's modulus relative to the uncarbonised porous polymer is about 50% to about 200%, about 60% to about 200%, about 70% to about 200%, about 80% to about 200%, about 90% to about 200%, about 100% to about 200%, about 100% to about 190%, about 100% to about 180%, about 100% to about 170%, about 100% to about 160%, or about 100% to about 150%. In some embodiments, the membrane substrate is characterised by an increase in Young's modulus relative to the uncarbonised porous polymer of about 130%.

In some embodiment, membrane substrate is formed as a flat sheet or a hollow fiber.

A monomer is a molecule that can react together with other monomer molecules to form a larger polymer chain or three-dimensional network in a process called polymerization. In this sense, monomers are used to form the polymer. The polymer thus comprises of monomeric units linked by covalent bonds.

In some embodiments, the COF layer has a pore size of about 0.5 nm to about 2 nm, about 0.5 nm to about 5 nm, or about 0.5 nm to about 10 nm. As the COF layer has a smaller pore size than the membrane substrate, the rejection and permeance of the solutes and solvents are regulated by the COF layer. In other embodiments, the pore size is about 0.5 nm to about 9 nm, about 0.5 nm to about 8 nm, about 0.5 nm to about 7 nm, about 0.5 nm to about 6 nm, about 0.5 nm to about 5 nm, about 0.5 nm to about 4 nm, about 0.5 nm to about 3 nm, or about 0.5 nm to about 2.5 nm. In some embodiments, the COF layer has a pore size of about 0.8 nm to about 2.4 nm.

In some embodiments, the COF membrane is characterised by a MWCO of about 300 Da to about 5000 Da. In other embodiments, the MWCO is about 400 Da to about 5000 Da, about 400 Da to about 4500 Da, about 400 Da to about 4000 Da, about 400 Da to about 3500 Da, or about 400 Da to about 3000 Da. In particular, the MWCO of Tp-HZ is about 400 Da, Tp-TAPB is about 700 Da, Tp-PDA is about 1200 Da and Tp-DHBD is about 3,000 Da.

In some embodiments, when the amino monomeric unit is HZ, the pore size is about 0.8 nm. In other embodiments, when the amino monomeric unit is TAPB, the pore size is about 1.2 nm. In other embodiments, when the amino monomeric unit is PDA, the pore size is about 1.8 nm. In other embodiments, when the amino monomeric unit is DHBD, the pore size is about 2.4 nm.

In some embodiments, the COF layer has a thickness of about 50 nm to about 500 nm. In other embodiments, the thickness is about 50 nm to about 450 nm, about 50 nm to about 400 nm, about 50 nm to about 350 nm, about 50 nm to about 300 nm, about 50 nm to about 250 nm, about 50 nm to about 200 nm, or about 50 nm to about 150 nm. In some embodiments, the COF layer has a thickness of about 100 nm.

In some embodiments, the COF layer is characterised by an X-ray diffraction (XRD) 2θ value of about 3° to about 8°. For example, when the amino monomeric unit is HZ, the value of about 7.1°. In other embodiments, when the amino monomeric unit is TAPB, value of about 5.7°. In other embodiments, when the amino monomeric unit is PDA, value of about 4.8°. In other embodiments, when the amino monomeric unit is DHBD, 20 value of about 3.6°. These values correspond to the reflection from the 100 plane.

In some embodiments, the COF membrane is characterised by a dye rejection of more than about 50%. In other embodiments, the dye rejection is more than about 55%, about 60%, about 65%, about 70%, about 75%, about 80%, about 85%, about 90%, about 95%, or about 99%.

In some embodiments, the COF membrane is characterised by a Evans blue rejection of more than about 90%. Evans blue has a molecular weight of about 960 Da. In other embodiments, the dye rejection is more than about 91%, about 92%, about 93%, about 94%, about 95%, about 96%, about 97%, about 98%, or about 99%.

In some embodiments, when the amino monomeric unit is HZ, the COF membrane is characterised by a Evans blue rejection of more than about 99.5%.

In some embodiments, the COF membrane is characterised by a methyl blue rejection of more than about 80%. Methyl blue has a molecular weight of about 799 Da. In other embodiments, the dye rejection is more than about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, or about 99%.

In some embodiments, when the amino monomeric unit is HZ, the COF membrane is characterised by a methyl blue rejection of more than about 99.5%.

In some embodiments, the COF membrane is characterised by a fuchsin acid rejection of more than about 75%. Methyl blue has a molecular weight of about 585 Da. In other embodiments, the dye rejection is more than about 76%, more than about 77%, more than about 78%, more than about 79%, more than about 80%, more than about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, or about 99%.

In some embodiments, when the amino monomeric unit is HZ, the COF membrane is characterised by a fuchsin acid rejection of more than about 95%.

In some embodiments, the COF membrane is characterised by a methyl orange rejection of more than about 50%. Methyl blue has a molecular weight of about 327 Da. In other embodiments, the dye rejection is more than about 55%, about 60%, about 61%, about 62%, about 63%, about 64%, about 65%, about 66%, about 67%, about 68%, about 69%, about 70%, about 71%, about 72%, about 73%, about 74%, about 75%, about 76%, more than about 77%, more than about 78%, more than about 79%, more than about 80%, more than about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, or about 99%.

In some embodiments, when the amino monomeric unit is HZ, the COF membrane is characterised by a methyl orange rejection of more than about 91%.

In some embodiments, the COF membrane is characterised by a water permeance of about 50 L m⁻² h⁻¹ bar⁻¹ to about 800 L m⁻² h⁻¹ bar⁻¹. In other embodiments, the water permeance is about 100 L m⁻² h⁻¹ bar⁻¹ to about 800 L m⁻² h⁻¹ bar⁻¹, about 150 L m⁻² h 1 bar⁻¹ to about 800 L m⁻² h⁻¹ bar⁻¹, about 150 L m⁻² h⁻¹ bar⁻¹ to about 700 L m⁻² h⁻¹ bar⁻¹, about 150 L m⁻² h⁻¹ bar⁻¹ to about 600 L m⁻² h⁻¹ bar⁻¹, about 150 L m⁻² h⁻¹ bar⁻¹ to about 500 L m⁻² h⁻¹ bar⁻¹, about 150 L m⁻² h⁻¹ bar⁻¹ to about 400 L m⁻² h⁻¹ bar⁻¹, or about 150 L m⁻² h⁻¹ bar⁻¹ to about 350 L m⁻² h⁻¹ bar⁻¹.

In some embodiments, when the amino monomeric unit is HZ, the COF membrane is characterised by a water permeance of about 50 L m⁻² h⁻¹ bar⁻¹ to about 800 L m⁻² h⁻¹ bar⁻¹. In other embodiments, the water permeance is about 100 L m⁻² h⁻¹ bar⁻¹ to about 800 L m⁻² h⁻¹ bar⁻¹, about 150 L m⁻² h⁻¹ bar⁻¹ to about 800 L m⁻² h⁻¹ bar⁻¹, about 150 L m⁻² h⁻¹ bar⁻¹ to about 700 L m⁻² h⁻¹ bar⁻¹, about 150 L m⁻² h⁻¹ bar⁻¹ to about 600 L m⁻² h⁻¹ bar⁻¹, about 150 L m⁻² h⁻¹ bar⁻¹ to about 500 L m⁻² h⁻¹ bar⁻¹, about 150 L m⁻² h⁻¹ bar⁻¹ to about 400 L m⁻² h⁻¹ bar⁻¹, about 150 L m⁻² h⁻¹ bar⁻¹ to about 350 L m⁻² h⁻¹ bar⁻¹, about 150 L m⁻² h⁻¹ bar⁻¹ to about 300 L m⁻² h⁻¹ bar⁻¹, about 150 L m⁻² h⁻¹ bar⁻¹ to about 250 L m⁻² h⁻¹ bar⁻¹, or about 150 L m⁻² h⁻¹ bar⁻¹ to about 200 L m⁻² h⁻¹ bar⁻¹.

In some embodiments, when the amino monomeric unit is HZ, the COF membrane is characterised by a water permeance of about 150 L m⁻² h⁻¹ bar⁻¹

In some embodiments, when the amino monomeric unit is DHBD, the COF membrane is characterised by a water permeance of about 200 L m⁻² h⁻¹ bar⁻¹ to about 800 L m⁻² h⁻¹ bar⁻¹. In other embodiments, the water permeance is about 100 L m⁻² h⁻¹ bar⁻¹ to about 800 L m⁻² h⁻¹ bar⁻¹, about 150 L m⁻² h⁻¹ bar⁻¹ to about 800 L m⁻² h⁻¹ bar⁻¹, about 150 L m⁻² h⁻¹ bar⁻¹ to about 700 L m⁻² h⁻¹ bar⁻¹, about 150 L m⁻² h⁻¹ bar⁻¹ to about 600 L m⁻² h⁻¹ bar⁻¹, about 150 L m⁻² h⁻¹ bar⁻¹ to about 500 L m⁻² h⁻¹ bar⁻¹, about 150 L m⁻² h⁻¹ bar⁻¹ to about 400 L m⁻² h⁻¹ bar⁻¹, about 200 L m⁻² h⁻¹ bar⁻¹ to about 400 L m⁻² h⁻¹ bar⁻¹, about 240 L m⁻² h⁻¹ bar⁻¹ to about 400 L m⁻² h⁻¹ bar⁻¹, about 300 L m⁻² h⁻¹ bar⁻¹ to about 400 L m⁻² h⁻¹ bar⁻¹, or about 300 L m⁻² h⁻¹ bar⁻¹ to about 350 L m⁻² h⁻¹ bar⁻¹.

In some embodiments, when the amino monomeric unit is DHBD, the COF membrane is characterised by a water permeance of about 320 L m⁻² h⁻¹ bar⁻¹.

In some embodiments, the COF membrane is characterised by a polar aprotic solvent permeance of about 10 L m⁻² h⁻¹ bar⁻¹ to about 100 L m⁻² h⁻¹ bar⁻¹. A polar aprotic solvent is a solvent that lacks an acidic proton and is polar. Such solvents lack hydroxyl and amine groups. These solvents do not serve as proton donors in hydrogen bonding, although they can be proton acceptors. In other embodiments, the permeance is about 10 L m⁻² h⁻¹ bar⁻¹ to about 90 L m⁻² h⁻¹ bar⁻¹, about 10 L m⁻² h⁻¹ bar⁻¹ to about 80 L m⁻² h⁻¹ bar⁻¹, about 10 L m⁻² h⁻¹ bar⁻¹ to about 70 L m⁻² h⁻¹ bar⁻¹, about 20 L m⁻² h⁻¹ bar⁻¹ to about 70 L m⁻² h⁻¹ bar⁻¹, about 30 L m⁻² h⁻¹ bar⁻¹ to about 70 L m⁻² h⁻¹ bar⁻¹, about 40 L m⁻² h⁻¹ bar⁻¹ to about 70 L m⁻² h⁻¹ bar⁻¹, or about 50 L m⁻² h⁻¹ bar⁻¹ to about 70 L m⁻² h⁻¹ bar⁻¹.

In some embodiments, the COF membrane is characterised by a polar aprotic solvent permeance of about 50 L m⁻² h⁻¹ bar⁻¹.

In some embodiments, the COF membrane is characterised by a NMP permeance of 20 L m⁻² h⁻¹ bar⁻¹ to about 100 L m⁻² h⁻¹ bar⁻¹. In other embodiments, the permeance is about 10 L m⁻² h⁻¹ bar⁻¹ to about 90 L m⁻² h⁻¹ bar⁻¹, about 10 L m⁻² h⁻¹ bar⁻¹ to about 80 L m⁻² h⁻¹ bar⁻¹, about 10 L m⁻² h⁻¹ bar⁻¹ to about 70 L m⁻² h⁻¹ bar⁻¹, about 20 L m⁻² h⁻¹ bar⁻¹ to about 70 L m⁻² h⁻¹ bar⁻¹, about 30 L m⁻² h⁻¹ bar⁻¹ to about 70 L m⁻² h⁻¹ bar⁻¹, about 40 L m⁻² h⁻¹ bar⁻¹ to about 70 L m⁻² h⁻¹ bar⁻¹, or about 50 L m⁻² h⁻¹ bar⁻¹ to about 70 L m⁻² h⁻¹ bar⁻¹.

In some embodiments, the COF membrane is characterised by a DMSO permeance of L m⁻² h⁻¹ bar⁻¹ to about 100 L m⁻² h⁻¹ bar⁻¹. In other embodiments, the permeance is about 10 L m⁻² h⁻¹ bar⁻¹ to about 90 L m⁻² h⁻¹ bar⁻¹, about 10 L m⁻² h⁻¹ bar⁻¹ to about 80 L m⁻² h⁻¹ bar⁻¹, about 10 L m⁻² h⁻¹ bar⁻¹ to about 70 L m⁻² h⁻¹ bar⁻¹, about 20 L m⁻² h⁻¹ bar⁻¹ to about 70 L m⁻² h⁻¹ bar⁻¹, about 30 L m⁻² h⁻¹ bar⁻¹ to about 70 L m⁻² h⁻¹ bar⁻¹, about 40 L m⁻² h⁻¹ bar⁻¹ to about 70 L m⁻² h⁻¹ bar⁻¹, or about 50 L m⁻² h⁻¹ bar⁻¹ to about 70 L m⁻² h⁻¹ bar⁻¹.

In some embodiments, the COF membrane is stable against organic solvents for at least 60 days.

In some embodiments, the organic solvent is selected from DMF, NMP, DMSO, or a combination thereof.

In some embodiment, COF membrane is formed as a flat sheet or a hollow fiber.

The present invention also provides a COF membrane for use in separating a catalyst from an organic solvent. For example, the catalyst can be Pd(PPh₃)₄, Grubbs catalysts, metal transition catalysts, and organocatalysts.

In some embodiments, the COF membrane is characterised by a Pd(PPh₃)₄ rejection of more than about 95%.

The present invention also provides a method of recovering a compound from a solution, comprising nanofiltering the solution through the COF membrane as disclosed herein in order to form a retentate and a permeate, wherein the compound is retained in the retentate.

In some embodiments, a size of the compound is at least about 60% relative to a pore size of the COF membrane. In some embodiments, the size of the compound is at least about 65%, about 70%, about 75%, about 80%, about 85%, about 90%, about 95%, or about 100% relative to a pore size of the COF membrane.

Alternatively, the COF membrane may be characterised by a MWCO. The MWCO refers to the lowest molecular weight solute in which 90% of the solute is retained by the membrane, or the molecular weight of the molecule that is 90% retained by the membrane. Accordingly, by choosing a COF membrane with a suitable MWCO, the compound which has a larger MW than the MWCO of the COF membrane can be retained on the retentate.

In some embodiments, the COF membrane is characterised by a MWCO of about 300 Da to about 5000 Da. In other embodiments, the MWCO is about 400 Da to about 5000 Da, about 400 Da to about 4500 Da, about 400 Da to about 4000 Da, about 400 Da to about 3500 Da, or about 400 Da to about 3000 Da. In particular, the MWCO of Tp-HZ is about 400 Da, Tp-TAPB is about 700 Da, Tp-PDA is about 1200 Da and Tp-DHBD is about 3,000 Da.

The compound may be any compound which has a MW larger than the MWCO of the COF membrane. In some embodiments, the compound is an organometallic compound and/or an organic compound having a molecular weight of at least 600 Da.

In some embodiments, the COF membrane comprises 1,3,5-Triformylphloroglucinol (Tp) monomers and amino monomers selected from p-phenylenediamine (PDA), hydrazine hydrate (HZ), 1,3,5-tris (4-aminephenyl)benzene (TAPB), 3,3-dihydroxybenzidine (DHBD), or a combination thereof.

In some embodiments, the nanofiltration is performed under a pressure of about 1 bar, or about 2 bar. In other embodiments, the pressure is at least about 1 bar, about 2 bar or about 3 bar.

In some embodiments, the nanofiltration is performed under an inert atmosphere. The inert atmosphere can comprise mainly an inert gas. The inert gas may be selected from nitrogen, argon, helium and/or neon. In some embodiments, the nanofiltration is performed under an argon atmosphere.

In some embodiments, the method is characterised by a compound recovery yield of at least 90%. In other embodiments, the recovery yield is at least 91%, 92%, 93%, 94%, 95%, 96%, 97% or 98%.

In some embodiments, the method is characterised by a compound recovery of at least 1 g. In some embodiments, the method is characterised by a compound recovery of at least 1.5 g, 2 g, 2.5 g or 3 g.

In some embodiments, the method further comprises purifying the compound in the retentate. The compound may be dried.

In some embodiments, when the compound is a catalyst, the recovered catalyst is reusable in another catalytic cycle. In some embodiments, when the recovered catalyst is reused in another catalytic cycle, the catalytic yield is substantially similar to a catalytic cycle using fresh catalyst. For example, if the yield in a first cycle using fresh catalyst is about 88%, the yield in a second cycle using the recovered catalyst is about 88%. The standard deviation may be about 8%. It would be clear to the skilled person that this can be dependent on the skill of the researcher conducting the reaction.

In some embodiments, the recovered catalyst is reusable in at least 4 catalytic cycles. In other embodiments, the recovered catalyst is reusable in at least 5 cycles, 6 cycles, 7 cycles, 8 cycles, 9 cycles, 10 cycles, or 20 cycles.

In some embodiments, the method further comprises recovering a second compound from the permeate, comprising nanofiltering the permeate through a second COF membrane as disclosed herein in order to form a second retentate and a second permeate, wherein the second compound is retained in the second retentate; and wherein the second COF membrane has a smaller pore size relative to the first COF membrane. The second compound may have a smaller MW than the first compound.

### EXAMPLES

### Preparation of C-PAN Substrates

The C-PAN substrates were prepared by carbonisation of commercial PAN ultrafiltration membranes in a tube furnace. The PAN membranes were first immersed into a 0.5 mol L⁻¹ calcium nitrate aqueous solution for 24 h. After drying at room temperature, the PAN membranes together with a glass substrate were transferred into a tube furnace. The whole carbonisation was conducted under an air atmosphere. The temperature inside the tube furnace was first increased from 30 to 210° C. with a ramp rate of 2° C. min⁻¹. Then the PAN was carbonised under 210° C. for 90 min. After naturally cooling to room temperature, the carbonised PAN substrates were taken out from the tube furnace and then washed with water and ethanol, respectively. The carbonised porous PAN membranes were stored within deionized water before use.

### Test of Solvent Permeance and Molecular Weight Cut-Off (MWCO)

The solvent permeation performance of the prepared C-PAN substrates was evaluated in a dead-end filtration system. Water and common organic solvents were poured into the system with the prepared C-PAN substrates to test their solvent permeance. Before the test, the upstream side of the membrane was first kept at 2 bar for at least 2 h to reach a steady state. Then the permeate was collected and weighed three times at fixed intervals, and the average value of the permeance (J, L m⁻² h⁻¹ bar⁻¹) was obtained. The MWCO of membranes was measured via rejection experiments using polyethylene oxide (PEO) with different molecular weight (Mw=100,000, 300,000, 1,000,000, 2,000,000 and 5,000,000 Da) at a concentration of 50 ppm as feed solutions. The concentrations of permeate and feed solutions were determined by a total organic carbon analyzer.

### Characterisation of Carbonised Polyacrylonitrile (C-PAN) Substrates

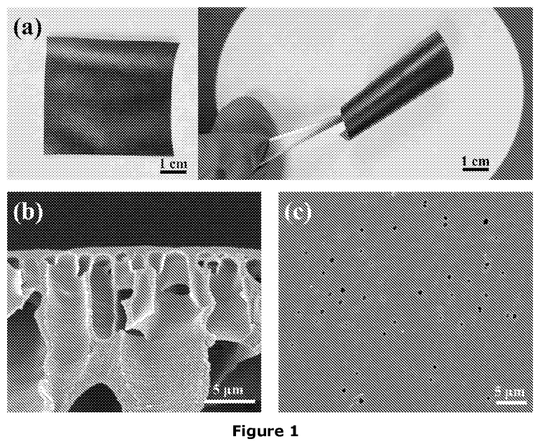

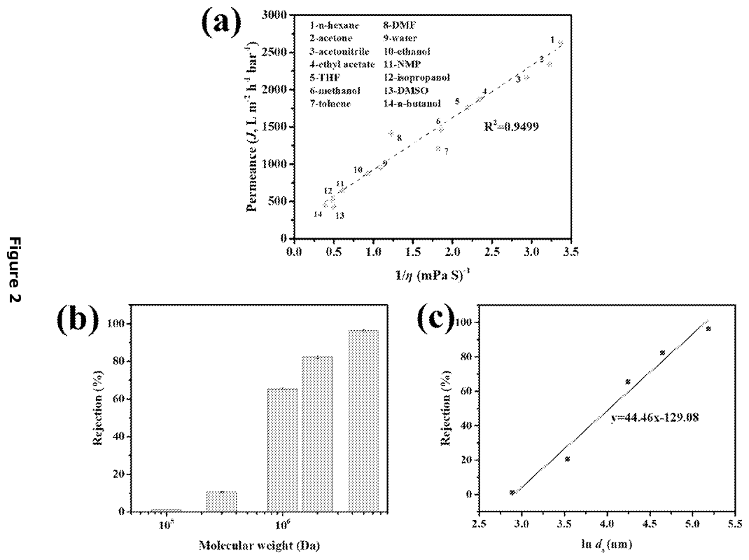

The carbonised polyacrylonitrile (C-PAN) substrates can be prepared by the carbonisation of commercial PAN ultrafiltration membranes with asymmetric pore structures. The C-PAN are flexible and robust and can be easily twisted as shown in FIG. 1a. The asymmetric finger-like pores remained after the carbonisation process as shown in its cross-sectional field-emission scanning electron microscopy (FESEM) image (FIG. 1b). Usually, the surface porosity of the commercial polymeric membranes is very low, resulting in a low flux for solvents. The MWCO of the commercial PAN membranes we used is ˜100,000, which corresponds to pore sizes of around 10 nm. Pore-forming agents, i.e. calcium nitrate, are used during the carbonisation process to produce large pores and enhance the porosity of the substrates. The surface FESEM images show that the pores with sizes of 100-500 nm were generated after the carbonisation. Therefore, the carbonised porous PAN membranes are expected to be ideal substrates with superior flux for solvent permeation.

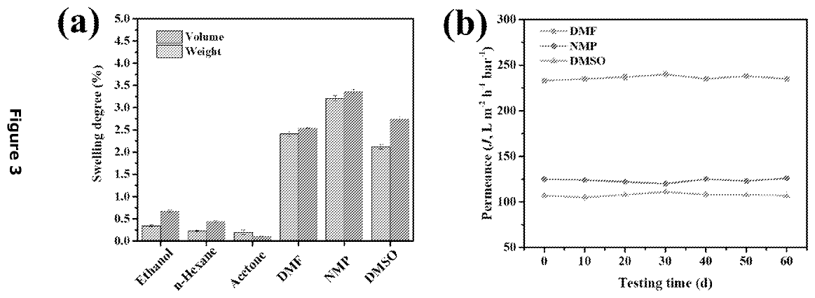

The MWCO of the C-PAN substrates was measured by rejecting PEO with different molecular weight as shown in FIGS. 2b and c. Since rejection is the log normal probability function of the solute size (dₛ), a straight line can be obtained when plotting a log normal probability curve of the rejection against solute size. The MWCO of the C-PAN was calculated to be 1471.2 kDa.

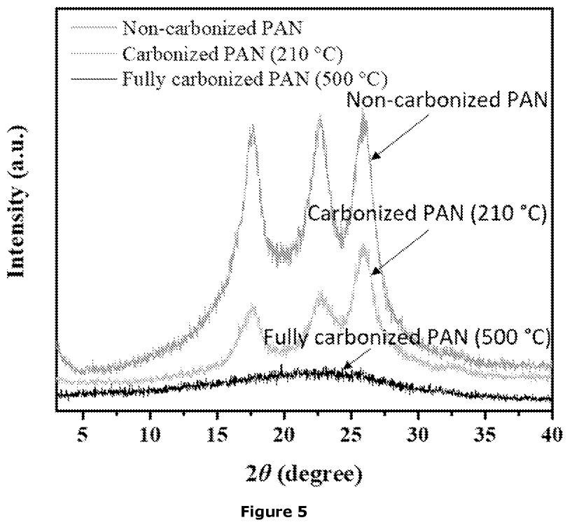

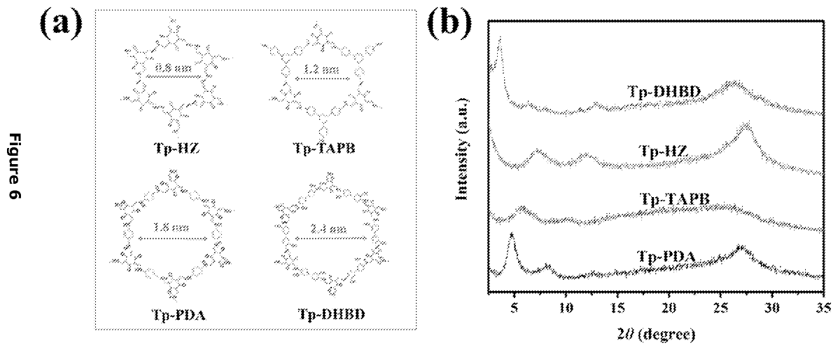

XRD characterization of the substrates where performed. A sample was partially carbonised at 210° C. and another sample was carbonised at 500° C. These samples were compared with the original non-carbonised substrate, As shown in FIG. 5, the carbonised substrates (210° C.) display weaker crystallinity peak intensity than the non-carbonised ones. The fully carbonised substrate shows amorphous structures at high temperature of 500° C.

### Solvent Permeance

Common polar and nonpolar organic solvents, including methanol, ethanol, isopropanol, n-butanol, ethyl acetate, acetone, acetonitrile, toluene, n-hexane, N,N-dimethylformamide (DMF), tetrahydrofuran (THF), N-methyl-2-pyrrolidone (NMP) and dimethyl sulfoxide (DMSO), as well as water were used to test the solvent permeance of the carbonised PAN. Interestingly, the carbonised porous PAN substrates could demonstrate outstanding water permeance of 956 L m⁻² h⁻¹ bar⁻¹, DMF permeance of 1415 L m⁻² h⁻¹ bar⁻¹ and n-hexane permeance of 2620 L m⁻² h⁻¹ bar⁻¹. To explore the molecular transfer mechanism, the relation between permeance (J) and molecular physical parameters is established. In FIG. 2a, the permeance of different solvents as a function of the reciprocal of the viscosity (n) is plotted. The relationship is J=K/η, where K is a proportionality constant. Such equation is identical to that of porous inorganic membranes with hydrophobic and permanent nanopores. Molecular transport is dominated by pore flow model (i.e., Poiseuille's law), which is mainly related to solvent viscosity.

In contrast, the water permeance of the original non-carbonised PAN substrate is 162 L m⁻² h⁻¹ bar⁻¹.

### Solvent Resistance

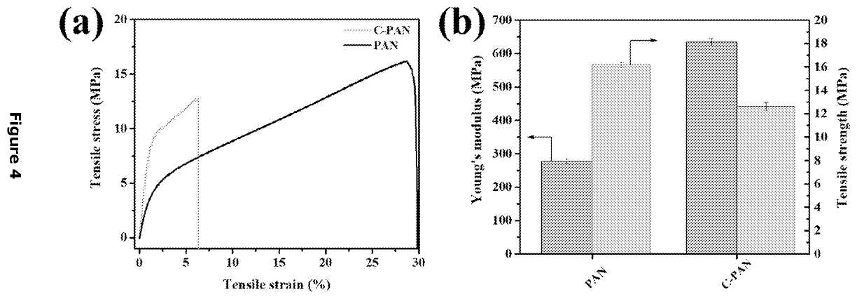

Six different solvents including polar protic solvents (ethanol and acetone), nonpolar aprotic solvents (n-hexane) and polar aprotic solvents (DMF, NMP and DMSO) were used to evaluate the swelling of the C-PAN substrates. The volume swelling and weight swelling degrees of the C-PAN substrates were calculated after 15 days' soaking in organic solvents as shown in FIG. 3a. The C-PAN substrates display excellent solvent resistance in those typical solvents with low volume swelling (from 0.2 to 3.2%) and solvent uptake (from 0.1 to 3.3%). The carbonisation of the PAN substrates leads to their structural transition from linear polymeric chains into highly cross-linked network structures with low conformational flexibility, thus dramatically enhancing the solvent resistance of the PAN substrates. In a long-term test, the C-PAN substrates were soaked in organic solvents for 60 days and they demonstrate excellent stability with aggressive organic solvents including DMF, NMP and DMSO.

In contrast, organic solvent swelling properties of the original non-carbonised PAN substrates cannot be tested since they can be dissolved in the aggressive organic solvents including DMF, NMP and DMSO.

### Mechanical Properties

The mechanical properties of PAN and C-PAN substrates were characterized by the tensile test with a stretching rate of 2 mm min⁻¹. The C-PAN shows a tensile strength of 12.6 MPa and Young's modulus of 634.5 MPa. The tensile strength of the C-PAN was decreased by 21% while Young's modulus was increased by 133% after the carbonisation. It can be concluded that the C-PAN substrates after carbonisation still demonstrate high mechanical properties, which can meet the requirements of the practical applications.

### Preparation of COF Membranes

The two-dimensional (2D) imine-linked COF membranes were in-situ synthesized on the carbonised polymeric substrates through interfacial polymerization. A mixture comprising amine monomer (p-phenylenediamine (PDA), hydrazine hydrate (HZ), 1,3,5-tris (4-aminephenyl)benzene (TAPB) or 3,3-dihydroxybenzidine (DHBD), 1.2 mM), p-toluene sulfonic acid (1.0 mM) and water was poured onto the surface of the substrates. The liquid on the substrates was removed after 1 min, and then a mixture of 1,3,5-triformylphloroglucinol (Tp, 0.9 mM) and mesitylene was poured onto the substrates. The system was kept static for 5 min and then the liquid on the substrate surface was removed. The as-prepared membranes were then immersed into an acetic acid aqueous solution (2.5 mM) at 60° C. for 36 h. The membranes were taken out from the acetic acid aqueous solution and then separately washed with ethanol, acetone and tetrahydrofuran to obtain the final COF membranes (denoted as Tp-PDA, Tp-HZ, Tp-TAPB and Tp-DHBD, respectively).

### Organic Solvent Nanofiltration Experiment

The organic solvent nanofiltration performance of the prepared COF membranes was evaluated in a dead-end system at room temperature. The performance of the membrane was evaluated via calculating rejection and organic solvent flux. Water and common organic solvents were poured into the setup with the prepared COF membranes to test their flux. Aqueous solutions containing dyes (100 ppm) or organic solutions containing metal catalysts (100 ppm) were poured into the setup with the prepared COF membranes to test the rejection. The pressure of the feed side was maintained at 2.0 bar. Before collecting samples, 0.5 h was given to the system for stabilization. The dye and catalyst rejections were determined by UV-Vis spectroscopy. The permeate samples were collected at least three times to obtain the average values and standard deviations of the final results.

### COF Membrane Characterisation

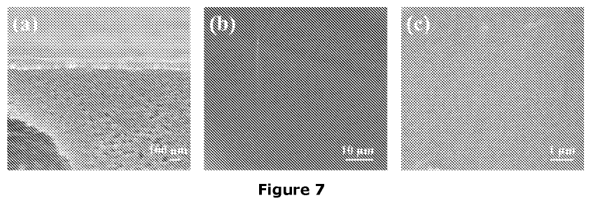

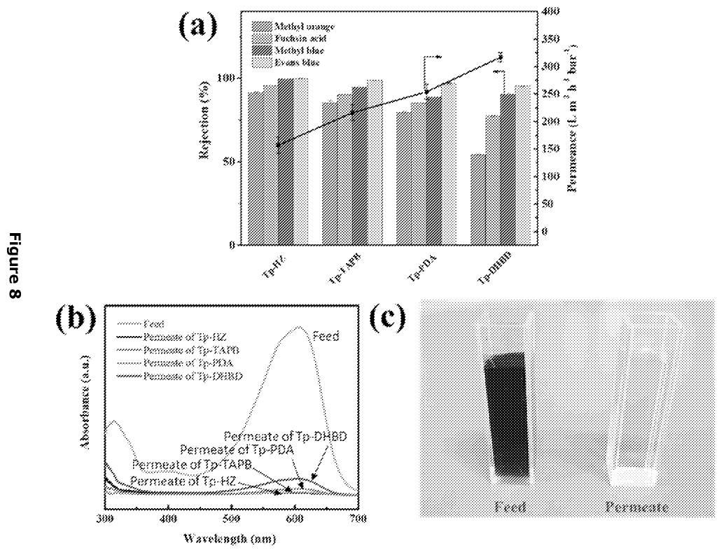

Four kinds of COF membranes with different pore sizes were fabricated by interfacial polymerization. The chemical structures and powder X-ray diffraction (PXRD) patterns of the COF membranes are shown in FIG. 6. The COF membranes show obvious peaks at lower 20 values, Tp-DHBD (3.6°), Tp-PDA (4.8°), Tp-TAPB (5.7°) and Tp-HZ (7.1°), which correspond to the reflections from the 100 plane. The characteristic PXRD patterns confirm their highly crystalline nature. The cross-sectional and surface morphology of the COF membranes were observed by field-emission scanning electron microscopy (FESEM). In FIG. 7a, the cross-sectional FESEM image shows that the COF layer with a thickness of ˜100 nm tightly adheres on the carbonised polymeric substrate, which benefits from the in-situ interfacial polymerization. The surface FESEM images of the COF membrane under different magnifications (FIGS. 7b and c) display its dense and void-free surface morphology.

### COF Membrane Dye Rejection

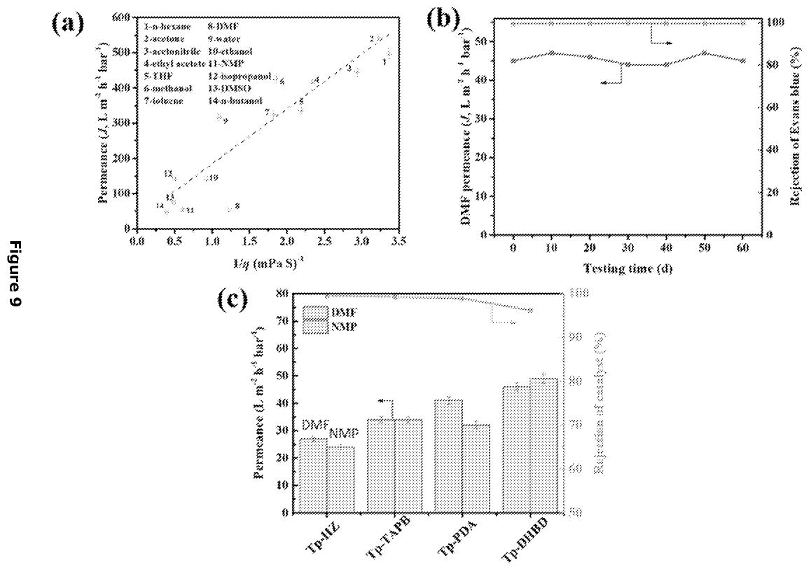

In order to investigate the relationship between the molecular weight cut-off (MWCO) and the pore sizes of the COF membranes, the dye rejection performance of the COF membranes was evaluated by four aqueous solutions of dyes (methyl orange (327 Da), fuchsin acid (585 Da), methyl blue (799 Da) and Evans blue (960 Da)) with a concentration of 100 ppm. The Tp-HZ membrane could reject Evans blue, methyl blue, fuchsin acid and methyl orange with rejections of 99.8, 99.5, 95.6 and 91.4%, respectively. FIGS. 8b and c show that the COF membrane could completely reject Evans blue in feed and yield purified water. The results demonstrate that the dyes with a molecular size larger than 1 nm can be easily retained by the Tp-HZ membrane with a pore size of 0.8 nm, and its water permeance can be higher than 150 L m⁻² h⁻¹ bar⁻¹. Compared with the Tp-HZ membrane, the COF membranes with larger pore sizes have relatively lower rejections for dyes. The Tp-DHBD membrane exhibits the highest water permeance of 317 L m⁻² h⁻¹ bar⁻¹ and rejections of higher than 90% for methyl blue and Evans blue.

### COF Membrane Solvent Permeation

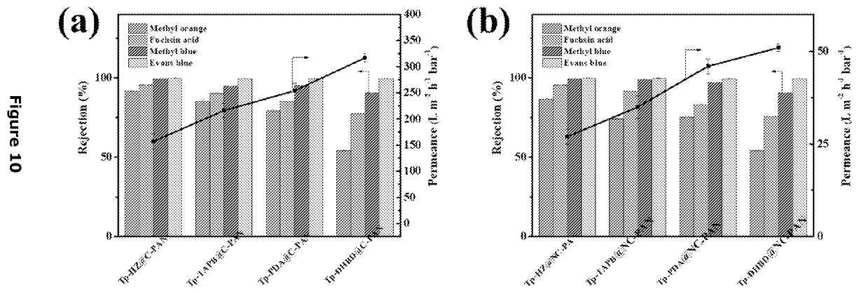

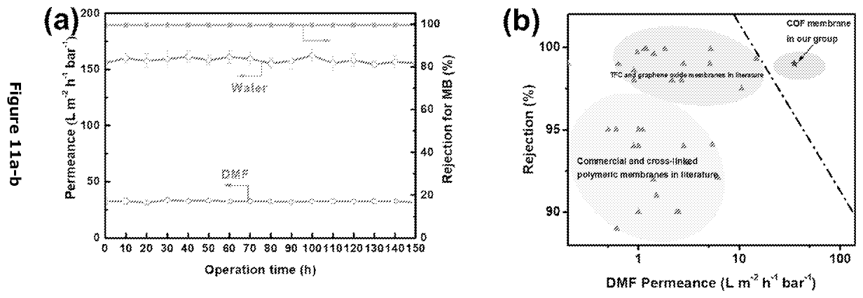

To test the solvent permeation properties of the COF membranes, thirteen common organic solvents, including methanol, ethanol, isopropanol, n-butanol, ethyl acetate, acetone, acetonitrile, toluene, n-hexane, N,N-dimethylformamide (DMF), tetrahydrofuran (THF), N-methyl-2-pyrrolidone (NMP) and dimethyl sulfoxide (DMSO) were utilized as shown in FIG. 9a. The pure solvent permeance is on the opposite order of their viscosity. The permeance of polar protic solvent (e.g. methanol) could be higher than 400 L m⁻² h⁻¹ bar⁻¹, which is due to the favorable affinity of the polar COF pore wall toward polar solvents. The permeance of polar aprotic solvent (e.g. DMF and NMP) of the COF membrane could be higher than 50 L m⁻² h⁻¹ bar⁻¹, which is more than times higher than that of the conventional polymeric membranes. The long-term operation stability of the COF membrane was tested by rejecting Evans blue in DMF as shown in FIG. 9b. The rejection was constant and the DMF permeance was stable during a 60-day test. The steady solvent permeance and high rejection confirm the high stability of COF membranes in aggressive organic solvents and also demonstrate their potential in practical applications.

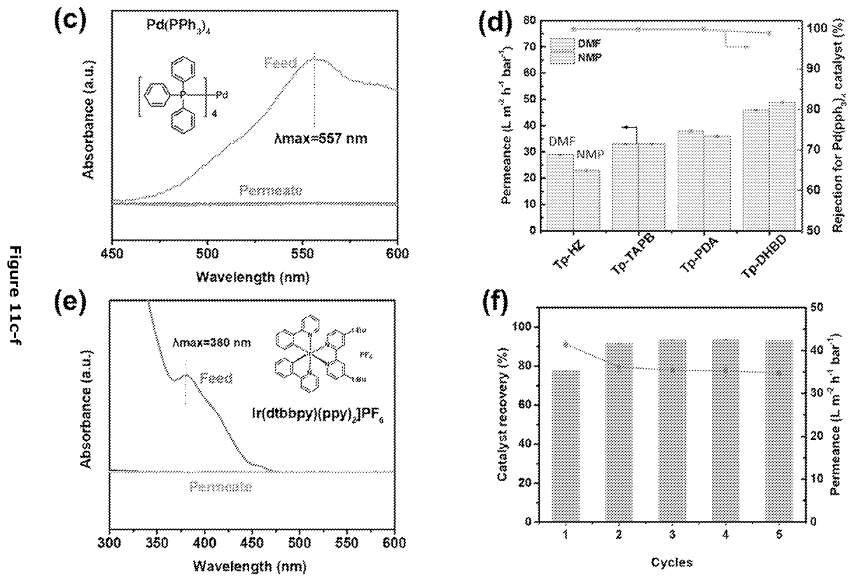

In contrast, FIG. 10 shows the water permeance and dye rejection of the COF membranes with non-carbonised polymeric substrates compared to COF membrane with carbonised PAN (C-PAN). It can be seen that the rejections of these two kinds of membranes are similar, but the COF membrane with C-PAN show 6 times higher water permeance of the latter ones. Further, the COF membranes with non-carbonised polymeric substrates are not stable in aggressive organic solvents like DMF, since the polymer can be dissolved in those solvents.

### COF Membrane Recovery of Homogenous Catalyst

The recovery of homogeneous catalysts by the COF membranes in organic solvent nanofiltration was performed. Catalyst recovery is a highly valuable operation in biomedical and chemical manufacturing industries, whereby most of the metal catalysts used are expensive, rare, and strictly regulated. Feed solutions of Pd(PPh₃)₄ in DMF or NMP (100 ppm) was used for catalyst recovery, in which the Pd(PPh₃)₄ is a typical metal catalyst in coupling reactions. The catalyst recovery performance of the 4 kinds of COF membranes was tested as shown in FIG. 9c. The rejection of Pd(PPh₃)₄ could be higher than 95% for all COF membranes. In addition, the COF membranes show high solvent permeance (25-50 L m⁻² h⁻¹ bar⁻¹) in the catalyst recovery. The results reveal a high potential of these COF membranes for catalyst recovery from aggressive organic solvents. The recovery of other kinds of expensive metal catalysts can also be performed. Other catalysts includes Grubbs catalysts (ruthenium complexes) for olefin metathesis, metal transition catalysts (iridium and ruthenium complexes) for photocatalytic reactions, and organocatalysts can also be recovered.

Comparative Results with Commercial Membranes

FIG. 11 shows additional results obtained from the COF membranes on the carbonized polymeric substrates by interfacial polymerization. These COF membranes demonstrated outstanding selectivity (>99.5%) and stable water permeance of 160 Lm⁻²h⁻¹bar⁻¹ and N,N-dimethylformamide (DMF) permeance of 32 Lm⁻²h⁻¹bar⁻¹ for a long-term dye rejection (FIG. 11a). Notably, this performance is superior to that of the commercial nanofiltration membranes. More importantly, it is comparable to the benchmarks set by thin-film composite (TFC) and graphene oxide membranes, thus indicating the potential of COF membranes for nanofiltration (FIG. 11b). TFC when made using polyamide is not stable in organic solvents while graphene oxide membranes cannot be scaled up easily. Furthermore, these COF membranes were utilized for recovering the homogeneous catalysts Pd(PPh₃)₄ and Ir[(dtbbpy)(ppy)₂]PF6, which are important and costly catalysts for coupling and photocatalytic reactions. The rejection of these catalysts may be higher than 99%, and a high catalyst recovery of 93% was achieved after 5 cycles of measurements (FIG. 11c-f). These results reveal the high potential of COF membranes for catalyst recovery from aggressive organic solvents, as well as other important metal catalysts and/or enzymes.

### Homogeneous Photocatalyst Recycling Using COF Membranes

The use of transition-metal-based homogeneous photocatalysts has opened up enormous opportunities for organic synthesis. However, the most efficient polypyridyl Ru (II) and Ir (III) complexes are among the rarest metals, significantly hampering their massive application, especially in industrial settings. Immobilizing these precious catalysts for recycling is challenging as the opaque solid resins or colored contamination can obstruct the light transmission. A versatile and sustainable strategy for the effective recovery of homogeneous photocatalysts by nanofiltration using covalent organic framework (COF) membranes is shown. A series of COF membranes with tunable pore sizes and excellent organic solvent resistance are prepared. The widely utilized Ru and Ir photoredox catalysts are recovered and reused for 10 cycles in various types of photochemical reactions, constantly achieving excellent catalytical performance and high recovery rates. The permeance of these COF membranes is two orders of magnitude higher than that of conventional polymeric membranes, making them suitable for scalable separation. The effectiveness of COF membrane-based nanofiltration by recycling a dual catalytical system and performing an operationally simple recovery of photocatalysts at a gram-scale is demonstrated. A cascade isolation of an Ir photocatalyst and purification of a small organic molecule product with COF membranes possessing different pore sizes is demonstrated. The results indicate an intriguing potential to shift the paradigm of the pharmaceutical and fine chemical synthesis campaign.

Using light as a form of clean and renewable energy to promote organic chemical synthesis has witnessed drastic developments over the past two decades. Chromophores based on noble metals such as polypyridyl Ru (II) and Ir (III) complexes represent the most versatile and effective photoredox catalysts, where both Ru and Ir have an abundance of around 0.001 ppm on the Earth's crust and are among the rarest metals. The scarcity and high price of those noble metals have significantly hampered their wide applications, especially in a large-scale industrial setting. There have been extensive attempts to replace noble-metal-based catalysts with more economical and sustainable photocatalysts, such as earth-abundant metals and organic dyes. Unfortunately, the low efficiency associated with the short lifetime of the excited state and poor photo-/chemical stability of these catalysts remain obstacles to their widespread adoption. On the other hand, immobilization of these homogeneous photocatalysts on solid resins is usually not applicable owing to the obstructed light transmission or low catalyst loading capacity of the solid resins. Therefore, developing a robust, energy-saving, and environmentally-friendly process for homogeneous photocatalyst recycling is of great economic and social significance.

Membrane-based nanofiltration could be an ideal approach for homogeneous photocatalyst recycling. Compared to conventional separation techniques, nanofiltration is less energy demanding, operationally simple, and with small spatial requirements. It avoids damage to heat-sensitive molecules (vs. rotovapping and distillation) and acid-sensitive molecules (vs. silica-gel-based chromatography). Current nanofiltration mostly relies on size-exclusion-based separation using either ceramic or polymeric membranes. Although ceramic membranes feature good chemical stability, they are usually expensive, and their scalable production and structural modification are still challenging. On the other hand, dense polymeric membranes can be readily processed and scaled up, forming the majority of membranes with industrial applications. However, the dense polymeric membranes are limited by low flux and poor chemical resistance to organic solvents. In recent years, various advanced porous polymer materials, such as covalent organic frameworks (COFs), have been developed based on reticular chemistry. Unlike amorphous polymers, COFs are crystalline due to their highly ordered structures. COFs with controllable pore size and highly regulated cross-linked frameworks are promising candidates for constructing advanced separation membranes. The customized pore sizes, consisting of atoms arranged in myriad structures with specific dimensions, are especially appealing for nanofiltration of small molecules, where the membranes can be optimized according to the three-dimensional molecular size of the target molecules. However, current COF membranes are mainly limited to water treatment. They have not seen successful application in homogeneous catalyst recovery due to the inadequate developments in organic solvent-resistant COF membranes.

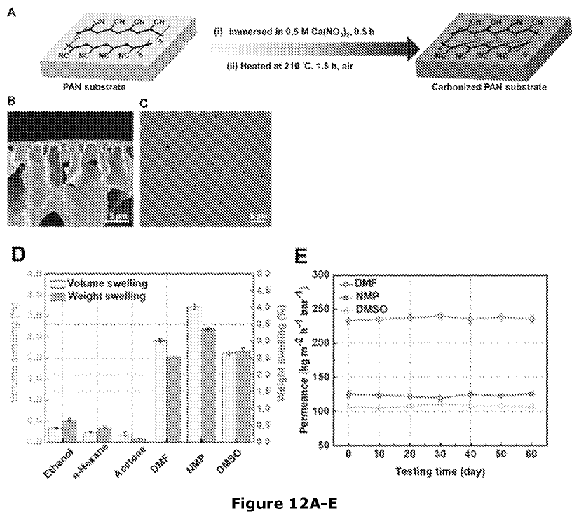

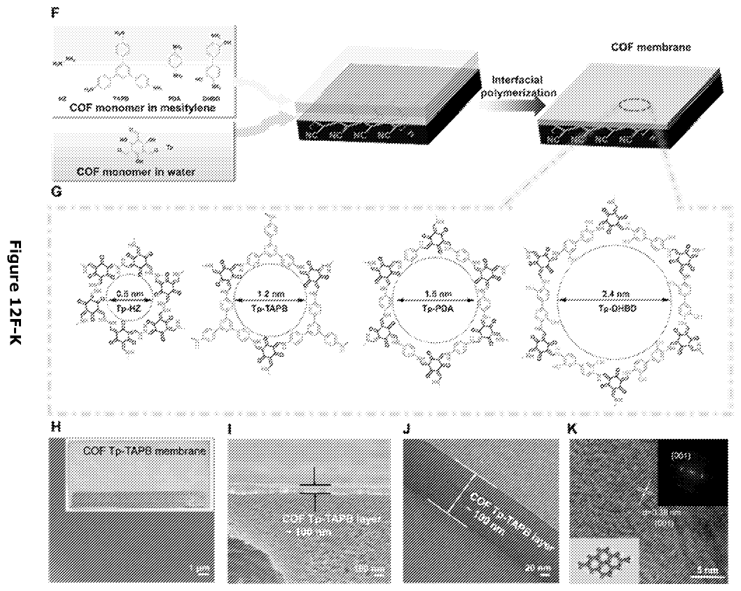

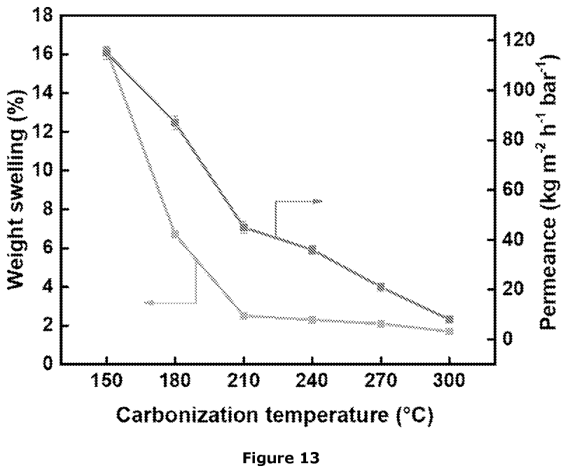

COF membrane is usually fabricated by the growth of a thin COF selective layer onto a polymeric substrate. However, commercial polymeric substrates possess low stability in polar organic solvents. Currently, reported methods for enhancing the stability of polymeric substrates include cross-linking, wet or dry annealing, drying by solvent exchange, and treatment with conditioning agents. However, most of these methods are challenging to scale up with limited stability enhancement and poor reproducibility. In this study, to improve the chemical resistance of polymeric substrates, we first prepared carbonized polyacrylonitrile (PAN) substrates by carbonizing commercial PAN ultrafiltration membranes under an inert atmosphere. The pore-forming agent, i.e., calcium nitrate, was employed during the carbonization process to produce large pores and enhance the porosity. The PAN substrates were then pyrolyzed at an optimized temperature of 210° C. under air to obtain carbonized PAN substrates with cross-linked structures (FIG. 12A). The carbonized PAN substrates could be easily scaled up and folded without rupturing. The asymmetric finger-like pores remained after the carbonization process, as shown in its cross-sectional field-emission scanning electron microscopy (FESEM) image (FIG. 12B). The surface FESEM image shows that pores with sizes of 100-500 nm were generated (FIG. 12C). Therefore, these carbonized PAN substrates were expected to provide superior fluxes for solvent permeation. The solvent resistance and permeance of the carbonized PAN substrates prepared at different temperatures were tested (FIG. 13). The volume and weight swelling degrees of the optimized carbonized PAN substrates were then measured after 15 days of soaking in 6 typical organic solvents (FIG. 12D). The carbonized PAN substrates displayed excellent solvent resistance with very low volume swelling (from 0.2 to 3.2%) and weight swelling (from 0.1 to 3.3%). In stark contrast, the uncarbonized PAN substrates showed much higher swelling degrees (>10%) in ethanol, n-hexane, and acetone; and were dissolvable in N,N-dimethylformamide (DMF), N-methyl-2-pyrrolidone (NMP), and dimethyl sulfoxide (DMSO). The dramatically enhanced solvent resistance of carbonized PAN substrates was mainly due to their structural transition from linear polymeric chains into highly cross-linked network structures with low conformational flexibility. In a long-term test, the carbonized PAN substrates demonstrated excellent stability in aggressive organic solvents for 60 days, including DMF, NMP, and DMSO (FIG. 12E). The mechanical properties of uncarbonized and carbonized PAN substrates were characterized by the tensile test with a stretching rate of 2 mm min⁻¹. The uncarbonized PAN exhibited a tensile strength of 12.6 MPa and Young's modulus of 634.5 MPa (FIG. 4). In contrast, the tensile strength of the carbonized PAN was decreased by 21%, while Young's modulus was increased by 133% after carbonization. These results indicate that the carbonized PAN substrates still demonstrate high mechanical properties to meet the requirements for practical applications. Water and organic solvents (both polar and nonpolar) were used to evaluate the solvent permeance (FIG. 2A). To explore the molecular transfer mechanism, we established the relation between permeance (J) and molecular physical parameters. The permeance of different solvents as a function of the reciprocal of the viscosity (η) was plotted, demonstrating a relationship of J=K/η, where K is a proportionality constant. Such an equation is identical to that of porous membranes with hydrophobic and permanent nanopores. Molecular transport is dominated by the pore flow model (i.e., Poiseuille's law), which is mainly related to solvent viscosity. The molecular weight cut-off (MWCO) of the carbonized PAN substrate was estimated to be around 1400 kDa (FIG. 2B, 2C).

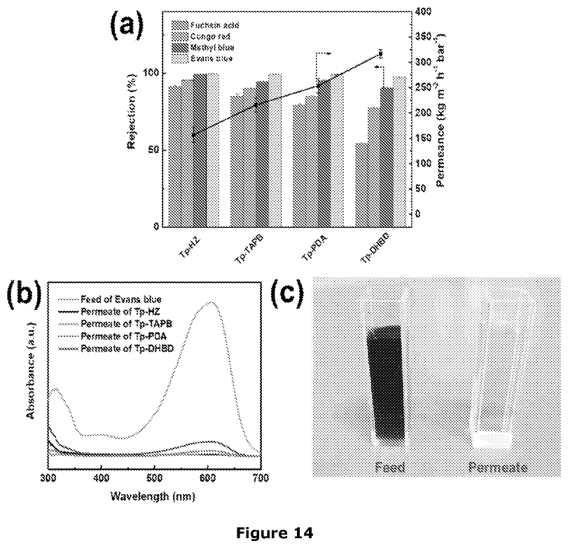

After the successful preparation of solvent-resistant carbonized PAN substrates, the two-dimensional (2D) imine-linked COF membranes were in-situ synthesized on the carbonized PAN substrates through interfacial polymerization (FIG. 12F). The aldehyde monomer 1,3,5-triformylphloroglucinol (Tp) and 4 different amine monomers (hydrazine hydrate (HZ), 1,3,5-tris (4-aminophenyl)benzene (TAPB), p-phenylenediamine (PDA), and 3,3-dihydroxybenzidine (DHBD)) were utilized to synthesize the COF membranes with different pore sizes, which are denoted as Tp-HZ, Tp-TAPB, Tp-PDA, and Tp-DHBD, respectively (FIG. 12G). The pore sizes of COF Tp-HZ, Tp-TAPB, Tp-PDA, and Tp-DHBD are 0.8, 1.2, 1.8, and 2.4 nm, respectively, obtained by the molecular simulation and reported pore size distribution results. The COF membranes show apparent X-ray diffraction (XRD) peaks at lower 20 values (Tp-DHBD: 3.6°, Tp-PDA: 4.8°, Tp-TAPB: 5.7°, and Tp-HZ: 7.1°), resulting from the reflections of the corresponding (100) planes (FIG. 6B). The characteristic XRD patterns confirm their highly crystalline nature. The surface FESEM images of the COF membranes (FIG. 12H) display dense and void-free surface morphology. FIG. 12H shows the surface morphology of a COF Tp-TAPB membrane inserted with its optical image. The cross-sectional FESEM images (FIG. 12I) demonstrate that the COF layer with a thickness of about 100 nm to about 150 nm tightly adheres to the carbonized polymeric substrate, benefitting from the in-situ interfacial polymerization. The cross-sectional transmission electron microscopy (TEM) image also shows a similar thickness of the COF layer (FIG. 12J), and the COF lattice was observed with a d-spacing of 0.38 nm, corresponding to the (001) plane (FIG. 12K). The chemical structures of these COF membranes were characterized by Fourier-transform infrared spectroscopy (FTIR) and ¹³C solid-state nuclear magnetic resonance (NMR). In order to investigate the MWCO of the COF membranes, we evaluated the dye rejection performance of these COF membranes using the aqueous solutions of four dyes (fuchsin acid (585 Da), Congo red (696 Da), methyl blue (799 Da), and Evans blue (960 Da)) with a concentration of 100 ppm each (FIG. 14). The results demonstrate that the Tp-HZ membrane, with a pore size of 0.8 nm, can easily retain the dyes larger than 1 nm, and its water permeance can be as high as 150 kg m⁻² h⁻¹ bar⁻¹. Compared with the Tp-HZ membrane, the COF membranes with larger pore sizes have relatively lower rejection and higher permeance. The pure solvent permeance of the COF Tp-TAPB membrane is illustrated in FIG. 9A, which is on the opposite order of the solvent viscosity. Notably, the permeance of polar aprotic solvent (e.g., DMF and NMP) of the COF membrane could be higher than 50 L m⁻² h⁻¹ bar⁻¹, which is more than 100 times higher than that of the conventional polymeric membranes. Long-term DMF permeance and dye rejection tests of these COF membranes were also conducted (FIGS. 9B and 9C), indicating high stability of these COF membranes for separations involving aggressive organic solvents. In addition, a comparison of separation performance of state-of-the-art membranes and as-synthesized COF membranes for dye rejection in DMF is shown in FIG. 11B. The performance of our COF membranes is superior to that of the commercial nanofiltration membranes as well as the state-of-the-art thin-film composite (TFC) and graphene oxide membranes, thus indicating the potential of these COF membranes for nanofiltration of organic molecules.

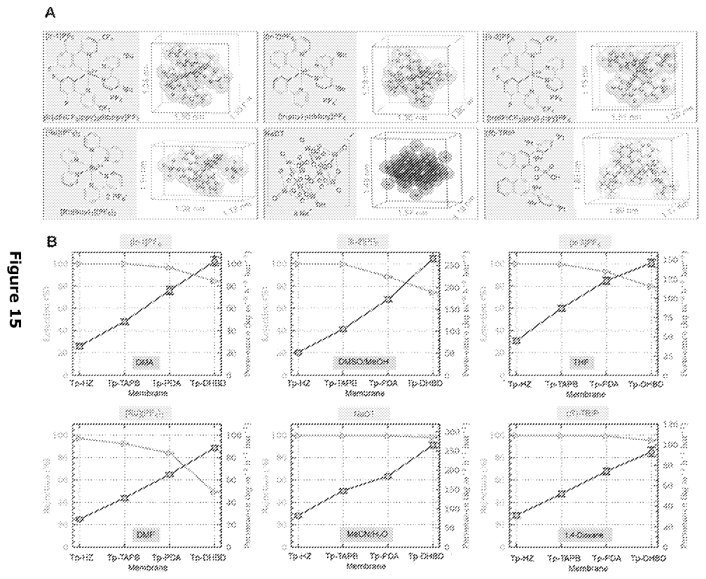

During nanofiltration-based catalyst recycling, molecular weight (MW) enlargement of catalyst/ligand is normally required to generate the MW gap between the catalyst and other solutes for efficient molecular separation. However, the noble metal photocatalysts in this study possess a distinct MW difference (MW>600) from most small organic molecules. Therefore, the customizable COF membranes with tunable pore sizes possess great opportunities for the direct separation of these photocatalysts. To investigate the performance of these as-synthesized COF membranes for recycling metal-based photocatalysts, we selected some well-known Ir- and Ru-photoredox catalysts, including [Ir{dF(CF₃)ppy}₂dtbbpy]PF₆ ([Ir-1]PF₆), [Ir(ppy)₂dtbbpy]PF₆ ([Ir-2]PF₆), [Ir{dF(CF₃)ppy}₂bpy]PF₆ ([Ir-3]PF₆), and [(Ru(bpy)₃](PF₆)₂([Ru](PF₆)₂), as well as one of the most widely utilized hydrogen atom transfer (HAT) photocatalyst NaDT. We targeted to cover the most common reaction types in photocatalysis, including photoredox, photo HAT, energy transfer (EnT), metallaphotoredox, and dual catalysis for enantioselective reactions. A chiral Brønsted acid (R)-TRIP was involved in this dual catalytic enantioselective photo transformation, and its separation can indicate whether the current strategy is universal for catalyst recycling that goes beyond metal-based photocatalysts. To test if the COF membranes could withstand different aggressive solvents, we used a wide range of organic solvents in these reactions, including N,N-dimethylacetamide (DMA), hexafluoroisopropanol (HFIP), dichloromethane (DCM), methanol (MeOH), DMSO, acetonitrile (MeCN), tetrahydrofuran (THF), and 1,4-dioxane. The crystal structures and simulated molecular sizes of these catalysts are illustrated in FIG. 15A. The photocatalyst rejection and solvent permeance were initially tested using the as-prepared four kinds of COF membranes (FIG. 15B). All membrane permeance increased while the rejection showed a decreasing trend with the increasing pore sizes of COF membranes. Thus, we selected the optimal COF membranes with high rejection and permeance for each photocatalyst (Table 1).

TABLE 1
A list of optimal COF membranes for the
recovery of each kind of photocatalyst.

| Photocatalyst | Size | Optimal COF membrane |
|---|---|---|
| [Ir-1]PF₆ | 1.50 nm × 1.38 nm × 1.34 nm | Tp-TAPB |
| [Ir-2]PF₆ | 1.60 nm × 1.36 nm × 1.29 nm | Tp-TAPB |
| [Ir-3]PF₆ | 1.51 nm × 1.20 nm × 1.15 nm | Tp-TAPB |
| [Ru](PF₆)₂ | 1.92 nm × 1.12 nm × 1.10 nm | Tp-HZ |
| NaDT | 1.57 nm × 1.48 nm × 1.10 nm | Tp-DHBD |
| (R)-TRIP | 1.90 nm × 1.39 nm × 1.11 nm | Tp-TAPB |

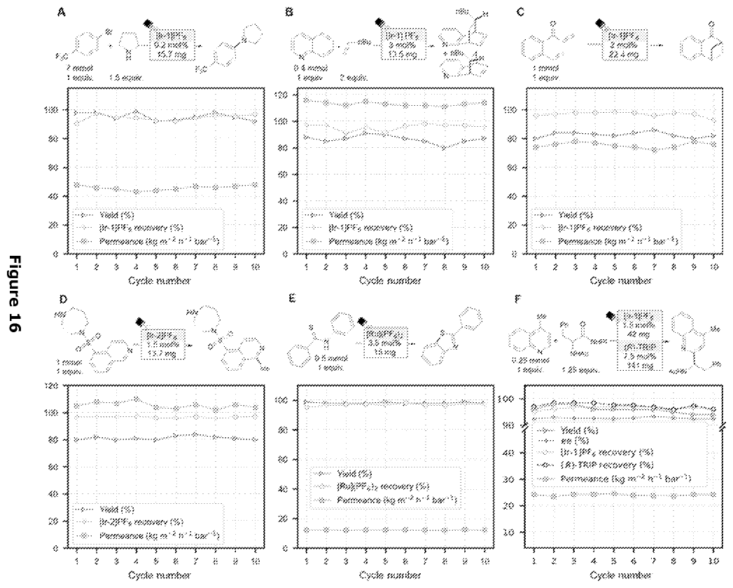

We subsequently evaluated the photocatalyst recycling performance of six different homogeneous photocatalysis reactions in conventional batch reactors, including a metallaphotoredox promoted aryl amination (FIG. 16A and table 2), an intermolecular [4+2] cycloaddition (FIG. 16B and table 3), an intramolecular [2+2] cycloaddition through EnT (FIG. 16C and table 4), a methylation of heteroarenes (FIG. 16D and table 5), a photo Meerwein arylation by SET (FIG. 16E and table 6), and a dual catalytic enantioselective Minisci-type addition (FIG. 16F and table 7). After each reaction, the solution mixture was directly filtered at room temperature through the optimal COF membrane under argon (2 bar). The photocatalyst was further washed using the corresponding reaction solvents and then directly subjected to the next reaction cycle. Each reaction-separation process was conducted for 10 cycles, and the reaction yield, enantioselectivity of the product, catalyst recovery rate, and permeance were recorded. These COF membranes enabled constantly high photocatalyst recovery rates (>95% in most cases) and high permeance (40-120 kg m⁻² h⁻¹ bar⁻¹) in 10 continuous recycling processes. Notably, the permeance of the COF membranes is two orders of magnitude higher than the conventional polymeric membranes for catalyst recovery. The reaction yields in 10 cycles were all steady, indicating the high catalytic activity of the recovered photocatalysts. After the final cycle, the purity of the recovered photocatalysts was confirmed by NMR analysis, showing no degradation of these noble metal catalysts. In particular, the dual catalytic Minisci-type reaction afforded excellent recovery rates for both Ir photocatalyst and organocatalyst (R)-TRIP, constantly obtaining excellent yields and ee values of the products. This study represents the first example of photocatalyst recovery by COF membranes, illustrating significant advantages of COF membranes in terms of high stability, facile adjustability, and excellent catalyst recovery performance. Besides, our study indicates that the COF membrane-based nanofiltration can be applied universally to different types of catalysts, such as organocatalysts and transition-metal catalysts, thus greatly expanding its applicability.

TABLE 2
Yields and catalyst recovery rates of the aryl amination reaction in ten cycles.

| Cycle | 1 | 2 | 3 | 4 | 5 | 6 | 7 | 8 | 9 | 10 |
|---|---|---|---|---|---|---|---|---|---|---|
| Yield | 98 | 98 | 94 | 99 | 92 | 93 | 95 | 98 | 95 | 92 |
| (%) | | | | | | | | | | |
| [Ir-1]PF₆ | 14.2 | 13.8 | 13.3 | 12.3 | 11.3 | 10.4 | 9.8 | 9.4 | 9.0 | 8.7 |
| (mg) | | | | | | | | | | |
| Catalyst | 90.6 | 97.3 | 95.0 | 94.3 | 92.8 | 92.0 | 94.2 | 95.9 | 95.7 | 96.7 |
| recovery | | | | | | | | | | |
| (%) | | | | | | | | | | |

TABLE 3
Yields and catalyst recovery rates of the intermolecular
cycloaddition via EnT in ten cycles.

| Cycle | 1 | 2 | 3 | 4 | 5 | 6 | 7 | 8 | 9 | 10 |
|---|---|---|---|---|---|---|---|---|---|---|
| Yield | 88 | 85 | 87 | 91 | 90 | 87 | 85 | 80 | 85 | 87 |
| (%) | | | | | | | | | | |
| [Ir-1]PF₆ | 12.8 | 12.5 | 11.4 | 10.8 | 9.9 | 9.6 | 9.4 | 9.1 | 8.8 | 8.4 |
| (mg) | | | | | | | | | | |
| Catalyst | 97.4 | 97.2 | 91.0 | 95.2 | 91.3 | 96.4 | 98.2 | 97.0 | 96.8 | 95.8 |
| recovery | | | | | | | | | | |
| (%) | | | | | | | | | | |

TABLE 4
Yields and catalyst recovery rates for the intramolecular
cycloaddition via EnT in ten cycles.

| Cycle | 1 | 2 | 3 | 4 | 5 | 6 | 7 | 8 | 9 | 10 |
|---|---|---|---|---|---|---|---|---|---|---|
| Yield | 80 | 84 | 84 | 83 | 82 | 84 | 86 | 82 | 80 | 82 |
| (%) | | | | | | | | | | |
| [Ir-1]PF₆ | 21.3 | 20.7 | 20.3 | 19.9 | 19.6 | 19.2 | 18.4 | 18.0 | 17.5 | 16.2 |
| (mg) | | | | | | | | | | |
| Yield (%) | 96 | 98 | 98 | 96 | 96 | 96 | 96 | 95 | 94 | 94 |
| ee (%) | 92.4 | 93 | 92.6 | 92.6 | 92.4 | 92.7 | 93.4 | 92.8 | 92.4 | 92.4 |
| [Ir-1]PF₆/ | 40 | 39 | 38 | 37 | 36 | 35 | 34 | 33 | 32 | 30 |
| mg | | | | | | | | | | |
| [Ir-1]PF₆ | 95.2 | 96.1 | 96.8 | 96.6 | 97.2 | 97.1 | 97.1 | 96.1 | 96.7 | 95.9 |
| recovery | | | | | | | | | | |
| (%) | | | | | | | | | | |
| (R)-TRIP/ | 137 | 135 | 133 | 131 | 128 | 125 | 122 | 117 | 114 | 110 |
| mg | | | | | | | | | | |
| (R)-TRIP | 97.1 | 98.5 | 98.5 | 98.4 | 97.7 | 97.6 | 96.8 | 95.9 | 97.4 | 96.1 |
| Catalyst | | | | | | | | | | |
| Recovery | | | | | | | | | | |
| (%) | | | | | | | | | | |
| Catalyst | 95.9 | 97.1 | 97.8 | 97.9 | 98.5 | 97.9 | 95.8 | 97.8 | 97.2 | 92.6 |
| recovery | | | | | | | | | | |
| (%) | | | | | | | | | | |

TABLE 5
Yields and catalyst recovery rates for the heteroarenes via SET in ten cycles.

| Cycle | 1 | 2 | 3 | 4 | 5 | 6 | 7 | 8 | 9 | 10 |
|---|---|---|---|---|---|---|---|---|---|---|
| Yield | 80 | 82 | 80 | 81 | 80 | 83 | 84 | 82 | 81 | 80 |
| (%) | | | | | | | | | | |
| [Ir-2]PF₆ | 11.6 | 11.3 | 10.9 | 10.6 | 10.2 | 9.8 | 9.5 | 9.1 | 8.8 | 8.6 |
| (mg) | | | | | | | | | | |
| Catalyst | 96.7 | 96.9 | 97.0 | 97.2 | 96.2 | 96.1 | 96.8 | 95.9 | 96.7 | 97.2 |
| recovery | | | | | | | | | | |
| (%) | | | | | | | | | | |

TABLE 6
Yields and catalyst recovery rates for the aromatic
C-H thiolation via SET in ten cycles.

| Cycle | 1 | 2 | 3 | 4 | 5 | 6 | 7 | 8 | 9 | 10 |
|---|---|---|---|---|---|---|---|---|---|---|
| Yield (%) | 99 | 98 | 98 | 98 | 99 | 98 | 99 | 99 | 98 | 98 |
| [Ru](PF₆)₂ | 14.3 | 13.8 | 13.5 | 13.2 | 12.8 | 12.6 | 12.2 | 11.8 | 11.5 | 11.2 |
| (mg) | | | | | | | | | | |
| Catalyst | 95.3 | 96.5 | 97.1 | 97.3 | 96.8 | 98.4 | 96.8 | 96.7 | 97.5 | 97.4 |
| recovery | | | | | | | | | | |
| (%) | | | | | | | | | | |

TABLE 7
Yields and catalyst recovery rates for the enantioselective
Minisci-type addition via SET in ten cycles.

[symbol]

[symbol]

indicates data missing or illegible when filed

The reactions in 10 cycles could maintain steady yields and the high catalytic activity, which indicates that the effective recovery and reuse of catalysts from the reactions have been achieved by COF membranes.

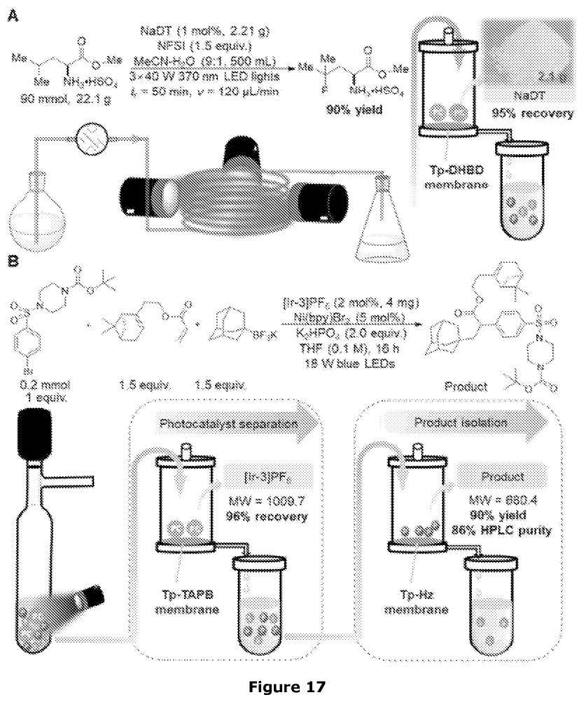

We attempted a gram-scale recovery of the photocatalyst to further demonstrate the practicality of COF-membrane-based nanofiltration. Direct access to γ-fluoroleucine in an operationally simple continuous-flow reactor was achieved through photocatalytic C—H fluorination using NaDT as a photo HAT catalyst. The reaction was performed on a 90-mmol-scale using 2.21 g NaDT (1 mol %). After 16 hours of continuous collection of products, 21.3 g (90% yield) (S)-γ-fluoroleucine was isolated, and 2.1 g NaDT was recovered by a dead-end filtration with a COF Tp-DHBD membrane at a 95% recovery rate (FIG. 17A). These results demonstrate the feasibility of COF membranes to handle high concentration feeds for nanofiltration. Owing to the modularity of COF membranes, we further attempted to achieve a more appealing but challenging cascade separation of reagents, photocatalysts, and products using COF membranes with different pore sizes. A three-component olefin difunctionalization was achieved using [Ir-3]PF₆ and nickel dual catalysis. We first separated [Ir-3]PF₆ photocatalyst by a dead-end filtration of the crude mixture through a COF Tp-TAPB membrane with a 96% recovery rate. Subsequently, the filtrate was subjected to a COF Tp-HZ membrane to purify the desired product from the remaining starting materials and nickel catalysts with 90% isolated yield (FIG. 17B). HPLC analysis indicated that the purity of product was increased from 77% from the crude reaction to 86% after membrane filtration, which also illustrated a very efficient separation of the product from small-molecule starting materials. The cascade catalyst recovery and product purification through membrane separation is manpower/energy-saving and solvent-economic, representing an ideal mode for downstream operation of homogeneous catalysis.

In summary, we prepared a series of solvent-resistant COF membranes with different pore sizes on carbonized polymeric substrates. The effective recovery and reuse of the most widely utilized metal-based photocatalysts from various types of photocatalysis reactions were achieved by dead-end nanofiltrations based on these COF membranes. The catalyst recovery from a dual-catalytic system or large-scale flow synthesis was feasible. Moreover, these COF membranes with different pore structures hold great potential for cascade separation/purification of catalysts and products in homogeneous photocatalysis. The highly customizable structures and high stability of COFs offer an intriguing opportunity to develop advanced membranes for on-demand recycling of homogeneous photocatalysts and purification of final products, thus laying a foundation for the future wide application of photocatalysis in an industrial setting.

### Materials and Methods

### 1.1 Chemicals and Materials

Polyacrylonitrile (PAN) was purchased from Shandong Lanjing Co Ltd. Calcium nitrate was purchased from Merck Pte Ltd. Ethanol (EtOH), N,N-dimethylformamide (DMF), methanol (MeOH), tetrahydrofuran (THF), acetonitrile (MeCN), and 1,4-dioxane were obtained from Avantor Performance Materials Inc. Polyethylene oxide (PEO) was purchased from Merck Pte Ltd. p-Phenylenediamine (PDA) was purchased from Alfa Aesar. 1,3,5-Tris (4-aminophenyl)benzene (TAPB) Mesitylene, p-toluene sulfonic acid (PTSA), 3,3-dihydroxybenzidine (DHBD), pyrrolidine, 2-mercaptopropionate, and 1-hexene were purchased from Tee Hai Chem Pte Ltd. Hydrazine hydrate (HZ) was purchased from Merck Pte Ltd. N-acetyl-L-phenylalanine (Ac-Phe-OH) was purchased from BLD Pharmatech Ltd. 1,3,5-Triformylphloroglucinol (Tp) was purchased from Yanshen Technology Co Ltd. 4-bromobenzotrifluoride, 4-methylquinoline, 1,4-diazabicyclo[2.2.2]octane (DABCO), 4-bromobenzenesulfonyl chloride, tert-butyl piperazine-1-carboxylate, hexafluoro-2-propanol (HFIP) was purchased from Oakwood. Quinoline, fasudil monohydrochloride, p-toluenesulfonic acid monohydrate (TsOH·H₂O), ethyl, N-fluorobenzenesulfonimide (NFIS), Nickel (II) bromide 2-methoxyethyl ether complex (NiBr₂·glyme), [(Ru(bpy)₃](PF₆)₂ (denoted as [Ru](PF₆)₂), [Ir{dF(CF₃)ppy}₂dtbbpy]PF₆ (denoted as [Ir-1]PF₆), [Ir(ppy)₂dtbbpy]PF₆ denoted as ([Ir-2]PF₆), [Ir{dF(CF₃)ppy}₂bpy]PF₆ denoted as ([Ir-3]PF₆), sodium decatungstate denoted as (NaDT), and (R)-3,3′-Bis (2,4,6-triisopropylphenyl)-1,1′-bi-2-naphthol cyclic monophosphate (denoted as (R)-TRIP) were purchased from Sigma-Aldrich Pte Ltd. Tert-butyl-4-((4-bromophenyl) sulfonyl) piperazine-1-carboxylate, adamantane trifluoroborate potassium salt, Ni(bpy)Br₂, 1,3-dioxoisoindolin-2-yl acetyl-L-phenylalaninate, N-phenylbenzothioamide, 1-(2-vinylphenyl)-propenone, Co^{III}(dmgH)₂ (4-NMe₂Py)Cl were prepared according to the reported procedures.

1.2 Characterization methods Scanning electron microscope (SEM) images of the membranes were observed via a field-emission scanning electron microscope (FESEM, JSM-7610F, JEOL). Crystal phase was characterized by X-ray diffraction (XRD) on an X-ray powder diffractometer (Rigaku MiniFlex 600) at a scan rate of 3° min⁻¹. Fourier-transform infrared spectroscopy (FTIR) spectra were obtained with a Nicolet 6700 FTIR spectrometer. The UV-Vis absorption spectra were tested through a UV3600 instrument. The product mixtures were analyzed by thin layer chromatography using TLC silica gel plates (MerckSchuchardt) with fluorescent indicator (λ=254 nm). The purification of the products was performed by flash column chromatography using silica gel 60 (63-200 μm) from SANPONT. ¹H NMR, ¹³C NMR, ³¹P NMR, and ¹⁹F NMR spectra were recorded on a Bruker AV-III400 (400 MHZ) or AMX500 (500 MHZ) spectrometer. Chemical shifts were calibrated using residual undeuterated solvent as an internal reference (CDCl₃: 7.26 ppm ¹H NMR, 77.16 ppm ¹³C NMR). Multiplicity was indicated as follows: s (singlet), d (doublet), t (triplet), q (quartet), m (multiplet), dd (doublet of doublet), td (triplet of doublets), dt (doublet of triplets), ddd (doublet of doublets of doublets), brs (broad singlet). All high-resolution mass spectra (HRMS) were obtained on a Finnigan/MAT95XL-T spectrometer. Analytic high performance liquid chromatography (HPLC) was performed using a Shimadzu Prominence System equipped with a Welch Ultimate@ XB-C18 column (10 UM, 250 mm×4.60 mm i.d.) at room temperature in a mixed solvent system of water and methanol. Chiral HPLC analysis was performed on a Shimadzu Prominence System equipped with chiralpak IC columns in a mixed solvent system of n-hexane and iso-propanol (Hexane/iPrOH=70/30, 1.0 mL/min, 30° C.).

### 2. Experimental

### 2.1 Preparation of Carbonized Polymeric Substrates

The carbonized PAN substrates were prepared by carbonization of commercial PAN substrates in a tube furnace. The PAN substrates were first immersed in a 0.5 mol L⁻¹ calcium nitrate aqueous solution for 24 h. After drying at room temperature, the PAN membranes together with a glass substrate were transferred into a tube furnace. The whole carbonization was conducted under an air atmosphere. The temperature inside the tube furnace was first increased from 30 to 210° C. with a ramp rate of 2° C. min⁻¹. Then the PAN was carbonized at 210° C. for 90 min. After naturally cooling to room temperature, the carbonized PAN substrates were taken out from the tube furnace and then washed with water and ethanol, respectively. The carbonized porous PAN membranes were stored within deionized water before use.

### 2.2 Preparation of COF Membranes

The two-dimensional (2D) imine-linked COF membranes were in-situ synthesized on the carbonized polymeric substrates through interfacial polymerization. A 20 mL mixture comprising amine monomer (HZ, TAPB, PDA or DHBD, 1.2 mM), p-toluene sulfonic acid (1.0 mM), and water was poured onto the surface of the carbonized substrates. The liquid on the substrates was removed after 1 min, then a 20 mL mixture of Tp (0.9 mM) and mesitylene was poured onto the substrates. The system was kept static for 5 min, and then the liquid on the substrate surface was removed. The as-prepared membranes were then immersed into an acetic acid aqueous solution (2.5 mM) at 60° C. for 36 h. The membranes were taken out from the acetic acid aqueous solution and then separately washed with ethanol, acetone, and THF to obtain the final COF membranes (denoted as Tp-HZ, Tp-TAPB, Tp-PDA, and Tp-DHBD, respectively).

### 2.3 Test of Solvent Permeance and Molecular Weight Cut-Off (MWCO) of Carbonized Substrates and COF Membranes

The solvent permeation performance of the prepared carbonized PAN substrates was evaluated in a dead-end filtration system. Water and common organic solvents were loaded into the system with the prepared carbonized PAN substrates to test their solvent permeance. Before the test, the upstream side of the membrane was first kept at 2 bar for at least 2 h to reach a steady state. Then, the permeate was collected and weighed three times at fixed intervals, and the average value of the permeance (J, kg m⁻² h⁻¹ bar⁻¹) was obtained. The MWCO of membranes was measured via rejection experiments using polyethylene oxide (PEO) with different molecular weight (Mw=100 k, 300 k, 1000 k, 2000 k and 5000 k Da) at a concentration of 50 ppm as feed solutions. The concentrations of permeate and feed solutions were determined by a total organic carbon analyzer (TOC ASI-5000A, Shimazu, Japan).

The MWCO of the prepared COF membranes was evaluated in a dead-end system at room temperature. The performance of the membrane was evaluated via calculating rejection and organic solvent flux. Water and common organic solvents were poured into the setup with the prepared COF membranes to test their flux. Aqueous solutions containing dyes (100 ppm) were poured into the setup with the prepared COF membranes to test the rejection. The pressure of the feed side was maintained at 2 bar. Before collecting samples, 0.5 h was given to the system for stabilization. The dye rejections were determined by UV-Vis spectroscopy. The permeate samples were collected at least three times to obtain the average values and standard deviations of the final results.

### 2.4 Customization of COF Membranes for Recovery of Photocatalysts

The screening of the optimal COF membranes for recovery of different photocatalysts was conducted in a dead-end organic solvent nanofiltration system at room temperature. The performance of the four kinds of COF membranes for rejecting each kind of photocatalyst in organic solvent (same as the corresponding reaction) was evaluated via calculating rejection and organic solvent permeance. The concentration of the feed is 1000 ppm, and the pressure of the feed side was maintained at 2.0 bar. Before collecting samples, 0.5 h was given to the system for stabilization. The rejections were determined by UV-Vis spectroscopy. The permeate samples were collected at least three times to obtain the average values and standard deviations of the final results.

### 2.5 Conduction of Photocatalysis Reactions and Photocatalyst Recovery by COF Membranes

### 2.5.1 Aryl Amination Via SET

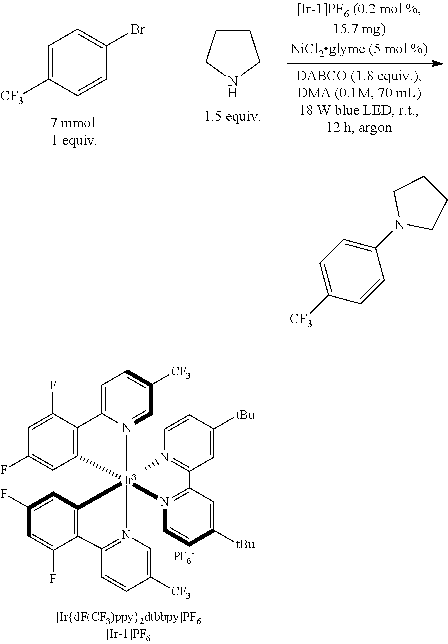

### General Procedure

A solution of DMA (70 mL) with photocatalyst [Ir-1]PF₆ (15.7 mg, 0.014 mmol, 0.2 mol %), NiBr₂·glyme (12.6 mg, 0.35 mmol, 5 mol %) and DABCO (1.41 g, 12.6 mmol, 1.8 equiv.) in a 100 mL round bottom flask was bubbled with argon for 15 min. Then 4-bromobenzotrifluoride (980 μL, 7 mmol, 1.0 equiv.) and pyrrolidine (877 μL, 10.5 mmol, 1.5 equiv.) were added to the above solution. The flask was placed under an atmosphere of argon and irradiated by 18 W blue LEDs. The flask was maintained at ambient temperature by cooling with a fan. After 12 h, 1 mL reaction mixture was taken out to examine the yield using CH₂Br₂ as internal standard. The rest solution was filtered through the COF Tp-TAPB membrane under an argon atmosphere (2 bar). After the nanofiltration, the COF membrane, together with the retentate, was washed with DMA (5×10 mL) under sonication for 30 min, and the solution of the recovered photocatalyst was obtained. The recovery rate of the photocatalyst was determined by UV-Vis absorption analysis. A total volume of 70 mL of DMA solution containing the recovered photocatalyst was placed in a 100 mL round bottom flask, bubbled with argon for 15 min and used for the next cycle. A total of 10 cycles of reactions and separations were conducted. After the final cycle, the recovered catalyst was dried and subjected to NMR analysis. The spectral data of 1-(4-(trifluoromethyl) phenyl) pyrrolidine matched that in the reported literature:

¹H NMR (400 MHZ, CDCl₃) δ 7.44 (d, J=8.2 Hz, 2H), 6.56 (d, J=8.8 Hz, 2H), 3.35-3.28 (m, 4H), 2.08-1.99 (m, 4H).

¹³C NMR (125 MHZ, CDCl₃) δ 149.88, 127.59, 126.53, 126.48, 126.43, 123.67, 116.96, 116.47, 110.95, 47.65, 25.60.

¹⁹F NMR (377 MHZ, CDCl₃) δ −60.6 (s).

### 2.5.2 Intermolecular Cycloaddition Via EnT

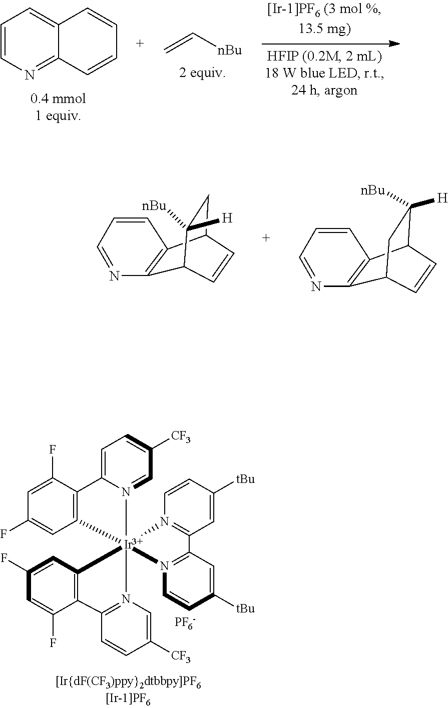

### General Procedure

A mixture of quinoline (51.6 mg, 0.4 mmol, 1 equiv.) and [Ir-1]PF₆ (13.5 mg, 3 mol %) in HFIP (2 mL, 0.2 M) was degassed by sparging with argon for 5 min with an outlet needle. Then 1-hexene (101 uL, 0.8 mmol) was added, and the Schlenk tube was sealed tightly and stirred under irradiation with 18 W blue LEDs. After the reaction, 18 mL HFIP was added to the solution to obtain a diluted mixture. The mixture was then filtered through the COF Tp-TAPB membrane under an argon atmosphere (2 bar). After the nanofiltration, the COF membrane, together with the retentate, was washed with EtOAc (5×10 mL) under sonication for 30 min. The resulting solution was analyzed by UV-Vis absorption to calculate the recovery rate of the [Ir-1]PF₆. The solution was concentrated by rotary evaporation and then dried under vacuum. The recovered [Ir-1]PF₆ was used for the next cycle. The permeate solution after nanofiltration was evaporated under reduced pressure, and then dibromomethane (14 μL, 0.2 mmol) was added to the residue for crude ¹H NMR measurement in CDCl₃ to determine the yield. A total of 10 cycles of reactions and separations were conducted. After the final cycle, the recovered catalyst was dried and analyzed by NMR. The spectral data of products matched that in the reported literature:

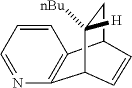

¹H NMR (400 MHZ, CDCl₃) δ 8.22 (dd, J=5.1, 1.6 Hz, 1H), 7.35 (dd, J=7.4, 1.7 Hz, 1H), 6.99 (dd, J=7.3, 5.1 Hz, 1H), 6.59 (ddd, J=7.7, 6.3, 1.5 Hz, 1H), 6.44 (ddd, J=7.6, 6.0, 1.4 Hz, 1H), 3.94-3.89 (m, 1H), 3.86 (dt, J=4.4, 1.6 Hz, 1H), 1.93-1.79 (m, 2H), 1.38-1.28 (m, 1H), 1.22-1.15 (m, 3H), 1.05-0.96 (m, 1H), 0.89 (ddd, J=11.1, 3.8, 2.2 Hz, 2H), 0.81 (t, J=7.1 Hz, 3H), 0.74-0.63 (m, 1H).

¹³C NMR (125 MHZ, CDCl₃) δ 162.82, 145.08, 137.92, 135.87, 134.41, 129.06, 120.49, 47.86, 39.72, 37.86, 36.17, 33.69, 30.16, 22.81, 14.15.

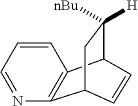

¹H NMR (400 MHZ, CDCl₃) δ 8.22 (dd, J=5.1, 1.6 Hz, 1H), 7.36 (dd, J=7.3, 1.6 Hz, 1H), 6.99 (dd, J=7.3, 5.1 Hz, 1H), 6.59-6.45 (m, 2H), 4.00 (dq, J=5.2, 2.3 Hz, 1H), 3.73 (dt, J=5.9, 2.0 Hz, 1H), 1.90 (ddd, J=11.7, 9.8, 3.1 Hz, 1H), 1.87-1.77 (m, 2H), 1.26-1.15 (m, 8H), 0.96 (ddd, J=11.7, 4.4, 2.4 Hz, 2H), 0.94-0.86 (m, 2H), 0.82 (t, J=7.1 Hz, 4H), 0.82-0.69 (m, 2H).

¹³C NMR (125 MHZ, CDCl₃) δ 164.90, 145.25, 136.05, 135.11, 134.36, 131.54, 120.28, 44.56, 43.26, 37.74, 35.96, 32.89, 29.84, 22.84, 14.20.

### 2.5.3 Intramolecular Cycloaddition Via EnT

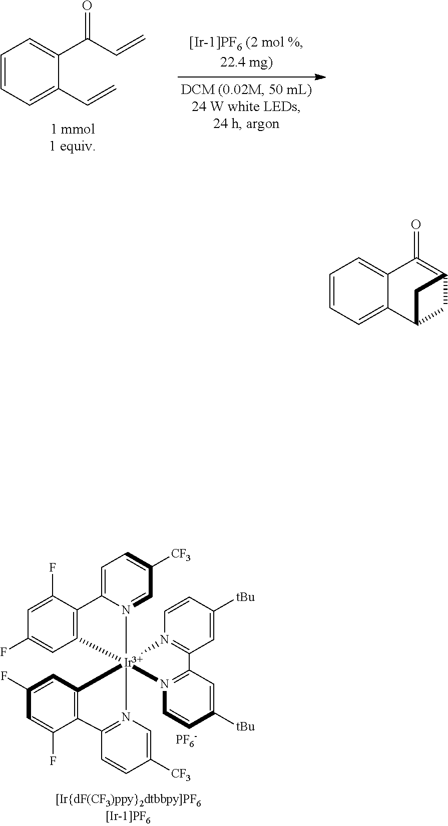

### General Procedure

A mixture of 1-(2-vinylphenyl)-propenone (158 mg, 1 mmol, 1 equiv.), [Ir-1]PF₆ (22.4 mg, 2 mol %), and DCM (50 mL, 0.02 M) in a 100 mL round bottom flask was degassed by sparging with argon for 5 min in an ice/water bath. The solution was stirred vigorously under irradiation with 24 W white LEDs. After 24 hours of reaction, the mixture was filtered through the COF Tp-TAPB membrane under an argon atmosphere (2 bar). After the nanofiltration, the COF membrane, together with the retentate, was washed with EtOAc (5×10 mL) under sonication for 30 min. The resulting solution was analyzed by UV-Vis absorption to calculate the recovery rate of the photocatalyst. Then the solution was concentrated by rotary evaporation and dried under vacuum. The recovered [Ir-1]PF₆ was used for the next cycle. The permeate solution after nanofiltration was evaporated under reduced pressure, and then dibromomethane (70 μL, 1 mmol) was added to the residue for crude ¹H NMR measurement in CDCl₃ to determine the yield. A total of 10 cycles of reactions and separations were conducted. After the final cycle, the recovered catalyst was dried and analyzed by NMR. The spectral data of the product matched that in the reported literature:

¹H NMR (400 MHZ, CDCl₃) δ 8.01-7.92 (m, 1H), 7.42 (td, J=7.4, 1.5 Hz, 1H), 7.33 (td, J=7.5, 1.3 Hz, 1H), 7.24-7.17 (m, 1H), 3.30 (q, J=5.7 Hz, 1H), 3.21 (q, J=5.8 Hz, 1H), 2.97-2.89 (m, 2H), 2.37-2.32 (m, 2H).

¹³C NMR (125 MHZ, CDCl₃) δ 201.88, 151.92, 133.31, 128.70, 127.19, 126.73, 125.03, 49.74, 44.04, 40.23.

### 2.5.4 Alkylation of Heteroarenes Via SET

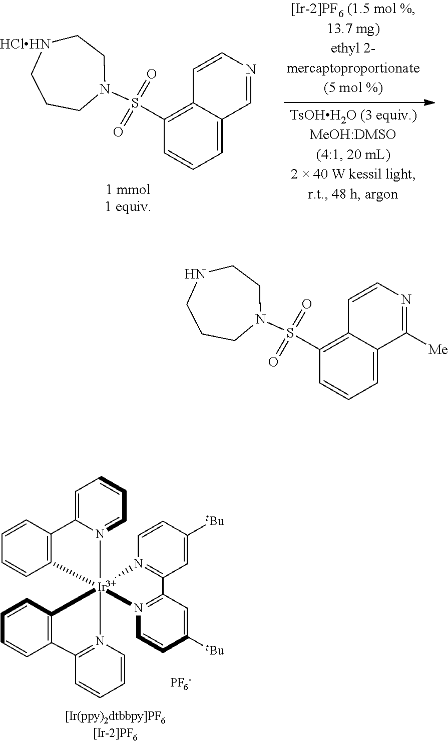

### General Procedure

[Ir-2]PF₆ (13.7 mg, 1.5 mol %), p-toluenesulfonic acid monohydrate (TsOH·H₂O, 570 mg, 3 mmol, 3.0 equiv.), fasudil monohydrochloride (327 mg, 1 mmol, 1.0 equiv.), 16 mL MeOH and 4 mL DMSO were added into a 50 mL Schlenk. The reaction mixture was degassed by sparging with argon for 10 min with an outlet needle. After adding ethyl 2-mercaptopropionate (5 mol %), the mixture was irradiated with 2×40 W blue LED at room temperature with a fan for cooling. After 48 hours of reaction, the mixture was filtered through the COF Tp-TAPB membrane under an argon atmosphere (2 bar). After the nanofiltration, the COF membrane, together with the retentate, was washed with EtOAc (5×10 mL) under sonication for 30 min. The resulting solution was analyzed by UV-Vis absorption to calculate the recovery rate of photocatalyst. Then the solution was concentrated by rotary evaporation and dried under vacuum. The recovered [Ir-2]PF₆ was used for the next cycle. The permeate solution was diluted with 1 M NaOH aqueous solution (4 mL) and DCM (30 mL), washed with brine (3×10 mL), dried over Na₂SO₄, and concentrated under reduced pressure. Dibromomethane was added to the residue for crude ¹H NMR in CDCl₃ to determine the yield. A total of 10 cycles of reactions and separations were conducted. After the final cycle, the recovered catalyst was dried and analyzed by NMR. The spectral data of the product matched that in the reported literature:

¹H NMR (500 MHz, CDCl₃): δ 8.53 (d, J=6.2 Hz, 1H), 8.37 (d, J=8.5 Hz, 1H), 8.33 (d, J=8.0 Hz, 1H), 8.30 (d, J=7.2 Hz, 1H), 7.66 (t, J=7.9 Hz, 1H), 3.48 (t, J=6.1 Hz, 2H), 3.43 (dd, J=6.4, 4.1 Hz, 2H), 3.02 (s, 3H), 2.96 (dd, J=6.3, 4.2 Hz, 2H), 2.93 (t, J=5.8 Hz, 2H), 1.86 (br s, 1H), 1.85-1.81 (m, 2H).

¹³C NMR (125 MHz, CDCl₃): δ 159.39, 143.65, 135.03, 132.42, 131.81, 131.01, 128.05, 125.31, 116.00, 51.18, 50.24, 47.67, 47.35, 31.22, 23.02.

### 2.5.5 Aromatic C—H Thiolation Via SET

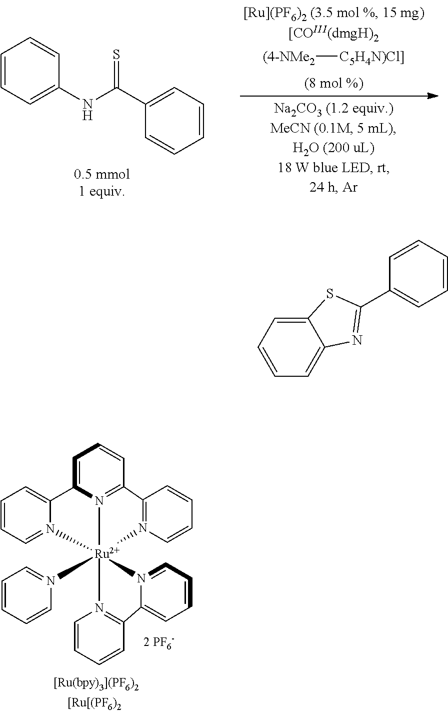

### General Procedure

Under argon atmosphere, a mixture of N-phenylbenzothioamide (106.5 mg, 0.5 mmol, 1 equiv.), [Ru](PF₆)₂ (15 mg, 3.5 mol %), Co^{III}(dmgH)₂ (4-NMe₂Py)Cl (17.8 mg, 8 mol %), Na₂CO₃ (64 mg, 0.6 mmol, 1.2 equiv.), H₂O (200 μL), and degassed dry MeCN (5 mL) in a 10 mL Schlenk tube was stirred under irradiation of 18 W blue LED for 24 h. After completion of the reaction, the solid was filtered off by filter paper and washed with 5 mL MeCN. The resulting homogenous mixture was filtered through the COF Tp-HZ membrane under an argon atmosphere (4 bar). After nanofiltration, the COF membrane, together with the retentate, was washed with EtOAc (5×10 mL) under sonication for 30 min. The resulting solution was analyzed by UV-Vis absorption to calculate the recovery rate of photocatalyst. Then the solution was concentrated by rotary evaporation and dried under vacuum. The recovered [Ru](PF₆)₂ was used for the next cycle. The permeate solution after nanofiltration was evaporated under reduced pressure. The yield was analyzed through crude ¹H NMR measurement in CDCl₃ using 1,3,5-trimethoxybenzene (28 mg, 0.167 mmol) as internal standard. A total of 10 cycles of reactions and separations were conducted. After the final cycle, the recovered catalyst was dried and analyzed by NMR. The spectral data of the product 2-phenylbenzo[d]thiazole matched that in the reported literature:

¹H NMR (400 MHZ, CDCl₃) δ 8.13-8.07 (m, 3H), 7.91 (d, J=7.9 Hz, 1H), 7.52-7.48 (m, 4H), 7.41-7.37 (m, 1H).

¹³C NMR (100 MHZ, CDCl₃) δ 168.14, 154.23, 135.15, 133.70, 131.04, 129.10, 127.64, 126.40, 125.27, 123.32, 121.70.

### 2.5.6 Enantioselective Minisci-Type Addition Via SET

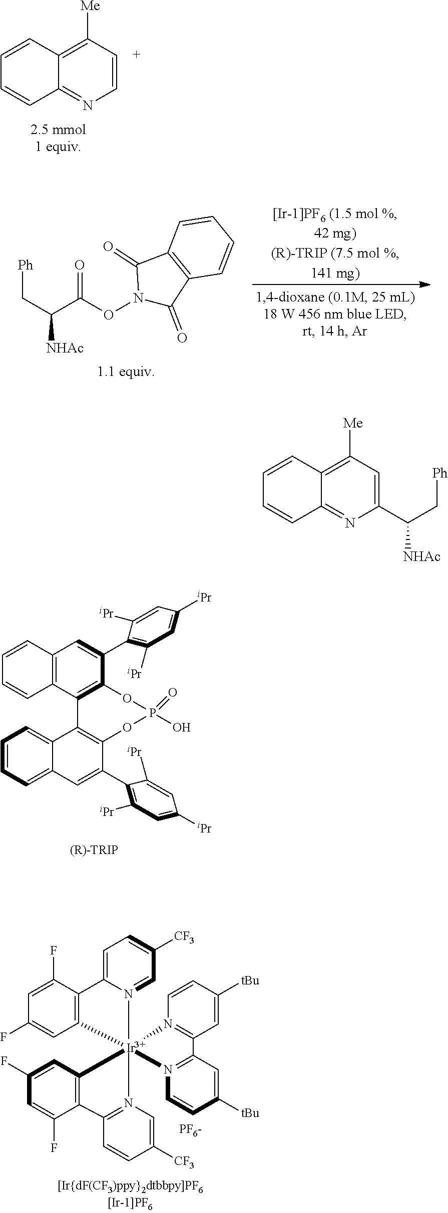

### General Procedure

A mixture of 4-methylquinoline (338 μL, 2.5 mmol, 1.0 equiv.), 1,3-dioxoisoindolin-2-yl acetyl-L-phenylalaninate (969 mg, 2.75 mmol, 1.1 equiv.), [Ir-1]PF₆ (42 mg, 1.5 mol %), (R)-TRIP (141 mg, 7.5 mol %), and 1,4-dioxane (25 mL) in a 100 mL round bottom flask was degassed by sparging with argon for 5 min with an outlet needle. Then the flask was irradiated with 18 W 456 nm blue LEDs. The apparatus was maintained at approximately room temperature with a fan. After 14 hours, the mixture solution was filtered through the COF Tp-TAPB membrane under an argon atmosphere (2 bar). After nanofiltration, the COF membrane, together with the retentate, was washed with EtOAc (5×10 mL) under sonication for 30 min. The resulting solution was analyzed by UV-Vis absorption to calculate the recovery rate. Then the retentate was concentrated by rotary evaporation and dried under vacuum. The recovered [Ir-1]PF₆ and (R)-TRIP were used for the next cycle. The permeate solution after nanofiltration was evaporated under reduced pressure. Dibromomethane (175 μL, 2.5 mmol) was added to the residue for crude ¹H NMR measurement in CDCl₃ to determine the yield. A total of 10 cycles of reactions and separations were conducted. After the final cycle, the recovered catalyst was dried and analyzed by NMR. The spectral data of the product matched that in the reported literature:

¹H NMR (400 MHZ, CDCl₃) δ 8.02 (dd, J=8.5, 1.3 Hz, 1H), 7.95 (dd, J=8.4, 1.4 Hz, 1H), 7.69 (ddd, J=8.4, 6.8, 1.4 Hz, 1H), 7.54 (ddd, J=8.3, 6.8, 1.3 Hz, 1H), 7.23 (br s, 1H), 7.15 (dt, J=4.5, 1.7 Hz, 3H), 6.98-6.91 (m, 2H), 6.80 (d, J=1.1 Hz, 1H), 5.39 (td, J=7.7, 5.2 Hz, 1H), 3.35 (dd, J=13.3, 5.2 Hz, 1H), 3.17 (dd, J=13.3, 7.9 Hz, 1H), 2.58 (s, 3H), 2.07 (s, 3H).

¹³C NMR (100 MHZ, CDCl₃) δ 169.53, 158.87, 147.28, 144.58, 137.36, 129.81, 129.59, 129.35, 128.19, 127.53, 126.52, 126.22, 123.92, 121.63, 55.59, 42.29, 23.68, 18.75.

2.5.7 Lage scale photocatalyst recovery

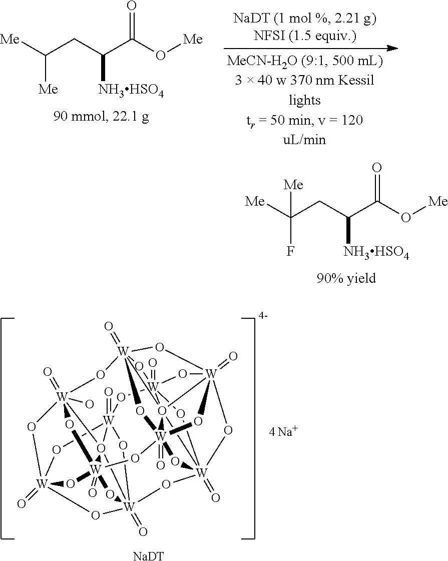

### General Procedure

(S)-Methyl-2-amino-4-methylpentanoate sulfate (22.1 g, 90 mmol), N-fluorobenzenesulfonimide (NFIS, 1.5 equiv.), and sodium decatungstate (NaDT, 2.21 g, 1 mol %) were dissolved in 500 mL mixed solution of MeCN—H₂O (9:1) then degassed by argon sparging for 15 min. The homogenous reaction mixture was pumped via syringe pump through a photoreactor (3×40 W 370 nm Kessil lights, total volume of 6 mL, 1/16″ I.D. tubing) at 120 μL/min (residence time of 50 min) and collected in a receiving bottle. The ¹H NMR yield (96%) was analysed by taking around 0.3 mL sample diluting with 0.3 mL CD₃CN/D₂O (9/1). After the reaction, the collected mixture was filtered through the COF Tp-DHBD membrane under argon (4 bar). After nanofiltration, the COF membrane, together with the retentate, was washed with water (5×20 mL) under sonication for 1 h. The recovered catalyst was obtained by vacuum drying and weighted to calculate the recovery rate (recovered NaDT 2.1 g, 95%). The permeate solution was concentrated to around 100 mL and dried by azeotropic distillation with 2-MeTHF (2×200 mL). Addition of 2-MeTHF (500 mL) precipitated the product, which was filtered, washed with 2-MeTHF and dried under a nitrogen stream. The isolated yield of(S)-methyl 2-amino-4-fluoro-4-methylpentanoate sulfate is 90% as an white amorphous solid.

### 2.5.8 Stepwise Separation of Photocatalysts and Products

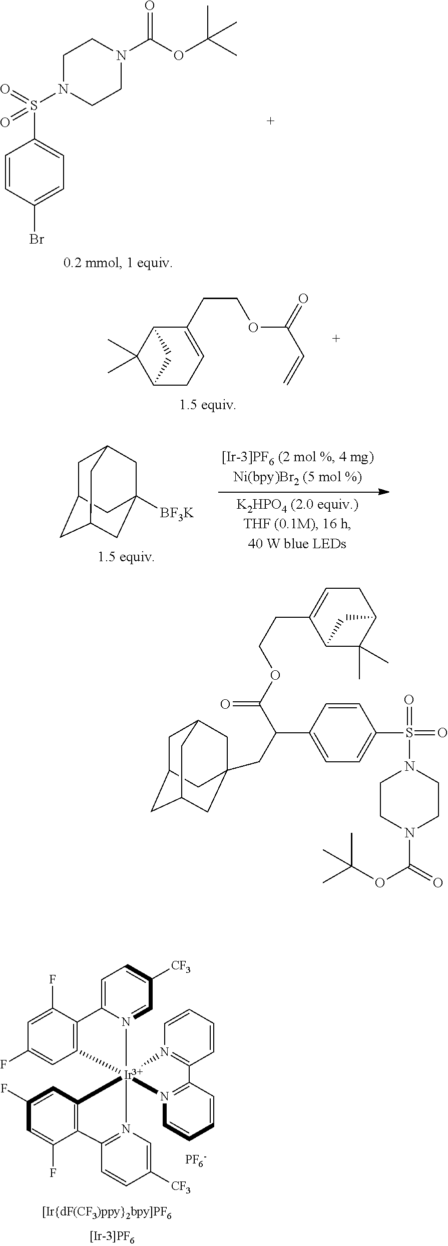

### General Procedure

1-Adamantane trifluoroborate potassium salt (72.6 mg, 0.3 mmol, 1.5 equiv.), tert-butyl 4-((4-bromophenyl) sulfonyl) piperazine-1-carboxylate (81 mg, 0.2 mmol, 1 equiv.), K₂HPO₄ (69 mg, 0.4 mmol, 2 equiv.), Ni(bpy)Br₂ (3.8 mg, 5 mol %), and [Ir-3]PF₆ (4.0 mg, 2 mol %) were added into a 10 mL Schlenk tube equipped with a stirrer bar. The tube was sealed, evacuated, and backfilled with argon three times. After adding 2-((1S,5R)-6,6-dimethylbicyclo[3.1.1]hept-2-en-2-yl) ethyl acrylate (66 mg, 0.3 mmol, 1.5 equiv.) and 2 mL degassed THF, the reaction mixture was irradiated with 456 nm, 18 W, blue LEDs for 12 hours at room temperature. The crude mixture was passed through a pad of Celite® and eluted with THF to remove the K₂HPO₄ salt. The yield was analyzed through crude ¹H NMR measurement in CDCl₃ using dibromomethane as internal standard.

After the reaction, the resulting solution was totally diluted to 10 mL and filtered through a COF Tp-TAPB membrane under argon (4 bar) to selectively separate the photocatalyst [Ir-3]PF₆ from other components. After nanofiltration, the COF membrane, together with the retentate, was washed with THF (5×10 mL), and the resulting solution was analyzed by UV-Vis absorption to calculate the recovery rate of [Ir-3]PF₆. The recovered catalyst was dried and analyzed by NMR.

The permeate solution from the first-step nanofiltration was further filtered through a COF Tp-HZ membrane under argon (4 bar) to selectively separate the products from the reactant residues. After nanofiltration, the COF membrane, together with the retentate, was washed with THF (5×10 mL) under sonication for 30 min. The yield of the product were analyzed through the crude ¹H NMR in CDCl₃ using dibromomethane as internal standard. The purity of the product was analyzed by HPLC.

NMR data analysis of product:

¹H NMR (400 MHZ, CDCl₃) δ 7.68-7.61 (m, 2H), 7.46 (dd, J=8.5, 1.5 Hz, 2H), 5.16 (ddd, J=15.7, 3.0, 1.5 Hz, 1H), 4.17-3.95 (m, 2H), 3.74 (dd, J=9.0, 3.8 Hz, 1H), 3.48 (t, J=5.1 Hz, 4H), 2.94 (t, J=4.9 Hz, 4H), 2.31-2.27 (m, 1H), 2.24-2.19 (m, 2H), 2.17-2.11 (m, 2H), 2.07-2.01 (m, 1H), 2.01-1.95 (m, 1H), 1.92 (dd, J=6.2, 3.3 Hz, 3H), 1.67 (d, J=12.6 Hz, 3H), 1.58 (d, J=12.5 Hz, 3H), 1.48 (dd, J=12.1, 2.9 Hz, 3H), 1.40 (d, J=6.5 Hz, 14H), 1.23 (d, J=2.6 Hz, 3H), 1.03 (dd, J=13.2, 8.6 Hz, 1H), 0.75 (dd, J=9.0, 2.4 Hz, 3H).

¹³C NMR (100 MHZ, CDCl₃) δ 173.87, 154.26, 146.83, 143.92, 143.89, 134.12, 128.85, 128.13, 118.96, 118.91, 80.50, 63.34, 48.14, 48.08, 46.47, 45.94, 45.66, 45.61, 42.34, 40.74, 40.72, 38.06, 36.96, 35.86, 33.12, 31.67, 31.43, 28.61, 28.39, 27.01, 26.35, 21.21.

HRMS (ESI, m/z) calcd for C₃₉H₅₆N₂NaO₆S [M+Na]⁺: 703.3750, found: 703.3751. NMR data analysis of byproduct:

¹H NMR (400 MHZ, CDCl₃) δ 5.31-5.25 (m, 2H), 4.06 (tt, J=7.5, 3.7 Hz, 4H), 2.36 (dt, J=8.6, 5.6 Hz, 2H), 2.30-2.19 (m, 11H), 2.05 (qd, J=6.4, 5.6, 2.2 Hz, 3H), 1.94 (s, 6H), 1.72-1.57 (m, 13H), 1.44 (d, J=2.9 Hz, 10H), 1.43-1.37 (m, 5H), 1.26 (s, 6H), 1.14 (d, J=8.5 Hz, 2H), 0.82 (s, 6H).

¹³C NMR (100 MHZ, CDCl₃) δ 174.86, 144.33, 118.84, 62.72, 45.78, 42.15, 40.84, 39.12, 38.13, 37.20, 36.07, 32.03, 31.77, 31.48, 28.72, 28.34, 26.41, 21.25.

HRMS (ESI, m/z) calcd for C₄₈H₇₀NaO₄ [M+Na]⁺: 733.5166, found: 733.5165.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Throughout this specification and the claims which follow, unless the context requires otherwise, the phrase “consisting essentially of”, and variations such as “consists essentially of” will be understood to indicate that the recited element(s) is/are essential i.e. necessary elements of the invention. The phrase allows for the presence of other non-recited elements which do not materially affect the characteristics of the invention but excludes additional unspecified elements which would affect the basic and novel characteristics of the method defined.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A method of forming a covalent organic framework (COF) membrane, comprising:
i) forming a membrane substrate by:
a) impregnating a porous polymer with a pore-forming agent in order to form an impregnated polymer;
b) at least partially carbonising the impregnated polymer at a temperature of about 150° C. to about 500° C. in order to form the membrane substrate;
wherein the membrane substrate is characterised by a crystallinity of about 10% to about 70% relative to the porous polymer; and
ii) interfacially polymerising amino monomers and acyl monomers on a surface of the membrane substrate in order to form the COF membrane;
wherein the acyl monomers are aldehyde monomers.

2. The method according to claim 1, wherein the amino monomer comprises at least two amino moieties, wherein the amino monomer is selected from p-phenylenediamine (PDA), hydrazine hydrate (HZ), 1,3,5-tris (4-aminophenyl)benzene (TAPB), 3,3-dihydroxybenzidine (DHBD), 2,2′-bipyridine-5,5′-diamine, 4,4′-azodianiline, 4,4′,4″-(1,3,5-triazine-2,4,6-triyl)trianiline, 4,4′,4″-(1,3,5-triazine-2,4,6-triyl) tris (1,1′-biphenyl)trianiline, benzidine, 2,5-diethoxy-terephthalohydrazide, 2,5-diaminebenzene-1,4-disulfonic acid, 2,5-diaminebenzenesulfonic acid, triphenylene hexamine, 1,4-phenylenediamine, melamine, 2,5-dimethylbenzene-1,4-diamine or a combination thereof.

3. (canceled)

4. The method according to claim 1, wherein the acyl monomer comprises at least two aldehyde moieties, wherein the acyl monomer is selected from 1,3,5-triformylphloroglucinol, 1,3,5-triformylbenzene, terephthalaldehyde, 4,4′-biphenyldicarboxaldehyde, 2,5-bis (2-propynyloxy)terephthalaldehyde, 2,5-dimethoxyterephthalaldehyde, 4,4′-biphenyldialdehyde, tetrathiafulvalene-tetrabenzaldehyde or a combination thereof.

5. (canceled)

6. The method according to claim 1 wherein the interfacial polymerisation comprises:
a) homogenously coating the surface of the membrane substrate with amino monomers in order to form a surface coated with amino monomers; and
b) homogenously coating the surface coated with amino monomers with acyl monomers; and
c) polymerising the amino monomers to the acyl monomers.

7. The method according to claim 1, wherein the amino monomers is provided in an aqueous medium at a concentration of about 0.1 mM to about 10 mM; wherein the acyl monomers is provided in an organic medium at a concentration of about 0.1 mM to about 10 mM.

8. The method according to claim 7, wherein the aqueous medium further comprises p-toluene sulfonic acid.

9. (canceled)

10. (canceled)

11. (canceled)

12. The method according to claim 1, wherein the polymerisation is performed in the presence of an acid at a concentration about 0.1 mM to about 10 Mm and/or at a temperature of about 40° C. to about 90° C. and/or for about 2 h to about 60 h.

13. (canceled)

14. The method according to claim 1, wherein the pore-forming agent is an inorganic metal salt selected from calcium nitrate, calcium chloride, magnesium chloride, sodium nitrate, potassium carbonate, aluminium nitrate or a combination thereof; and wherein the porous polymer is selected from polyacrylonitrile (PAN), polyethersulfone (PES), polyvinylidene fluoride (PVDF), polysulfone, sodium alginate, chitosan, polydimethylsiloxane, polyvinyl alcohol, poly (ether-ether-ketone), poly (methyl methacrylate) (PMMA), polytetrafluoroethylene (PTFE) or a combination thereof.

15. (canceled)

16. The method according to claim 1, wherein the impregnation step is performed for at least about 1 h; wherein the impregnated polymer is carbonised at a temperature of about 200° C., for about 30 min to about 360 min, and/or in the presence of oxygen.

17. (canceled)

18. (canceled)

19. The method according to claim 1, wherein the membrane substrate is characterised by a degree of carbonisation relative to the porous polymer of at least about 20% and/or an increase in pore size relative to the porous polymer of about 5 times to about 100 times.

20. (canceled)

21. A covalent organic framework (COF) membrane, comprising:
i) a membrane substrate comprising an at least partially carbonised porous polymer, the membrane substrate having a pore size of about 100 nm to about 800 nm, wherein the membrane substrate is characterised by a crystallinity of about 10% to about 70% relative to an uncarbonised porous polymer; and
ii) a COF layer interfacially polymerised on a surface of the membrane substrate, the COF layer formed from amino monomeric units and acyl monomeric units;
wherein the COF layer has a pore size of about 0.5 nm to about 10 nm.

22. The COF membrane according to claim 21, wherein the COF layer is characterised by at least one of the following:
a) a pore size of about 0.8 nm to about 2.4 nm;
b) a thickness of about 50 nm to about 500 nm;
c) an X-ray diffraction (XRD) 2θ value of about 3° to about 8°; and a dye rejection of more than about 90%.

23. (canceled)

24. (canceled)

25. The COF membrane according to claim 21, wherein when the amino monomeric unit is HZ, the COF membrane is characterised by at least one of the following:
i) a Evans blue rejection of more than about 99.5%;
ii) a methyl blue rejection of more than about 99.5%;
iii) a fuchsin acid rejection of more than about 95%;
iv) a methyl orange rejection of more than about 91%;
v) a water permeance of about 50 L m⁻² h⁻¹ bar 1 to about 800 L m⁻² h⁻¹ bar⁻¹; or, wherein when the amino monomeric unit is DHBD, the COF membrane is characterised by a water permeance of about 200 L m⁻² h⁻¹ bar⁻¹ to about 800 L m⁻² h⁻¹ bar⁻¹.

26. (canceled)

27. The COF membrane according to claim 21, wherein the COF membrane is characterised by at least one of the following:
i) a polar aprotic solvent permeance of about 10 L m⁻² h⁻¹ bar⁻¹ to about 100 L m⁻² h⁻¹ bar⁻¹;
ii) a NMP permeance of 20 L m⁻² h⁻¹ bar 1 to about 100 L m⁻² h⁻¹ bar⁻¹;
iii) a DMSO permeance of 20 L m⁻² h⁻¹ bar⁻¹ to about 100 L m⁻² h⁻¹ bar⁻¹.

28. The COF membrane according to claim 21, wherein the COF membrane is stable against organic solvents for at least 60 days, wherein the organic solvent is selected from DMF, NMP, DMSO, or a combination thereof.

29. (canceled)

30. The COF membrane according to claim 21, wherein the membrane substrate is an organic membrane substrate having a pore size of about 100 nm to about 300 nm; wherein the membrane substrate is characterised by a molecular weight cut-off (MWCO) of about 500 kDa to about 4000 kDa;
wherein the at least partially carbonised porous polymer is about 40% to about 70% carbonised; and/or when the COF membrane is used in separating a catalyst from an organic solvent the COF membrane is characterised by a Pd(PPh₃)₄ rejection of more than about 95%.

31. (canceled)

32. (canceled)

33. (canceled)

34. (canceled)

35. (canceled)

36. A method of recovering a compound from a solution, comprising nanofiltering the solution through the COF membrane according to claim 21 in order to form a retentate and a permeate, wherein the compound is retained in the retentate.

37. The method according to claim 36, wherein a size of the compound is at least about 60% relative to a pore size of the COF membrane; wherein the method is characterised by a compound recovery yield of at least 90% and/or a compound recovery of at least 1 g; wherein the COF membrane is characterised by a MWCO of about 300 Da to about 5000 Da; wherein the nanofiltration is performed under a pressure of about 2 bar and/or under an inert atmosphere wherein the compound is an organometallic compound and/or an organic compound having a molecular weight of at least 600 Da.

38. (canceled)

39. (canceled)

40. (canceled)

41. (canceled)

42. (canceled)

43. (canceled)

44. (canceled)

45. The method according to claim 36, wherein when the compound is a catalyst, the recovered catalyst is reusable in another catalytic cycle, wherein the catalytic yield is substantially similar to a catalytic cycle using fresh catalyst; wherein the recovered catalyst is reusable in at least 10 catalytic cycles.

46. (canceled)

47. (canceled)

48. The method according to claim 36, wherein the method further comprises recovering a second compound from the permeate, comprising nanofiltering the permeate through a second COF membrane as disclosed herein in order to form a second retentate and a second permeate, wherein the second compound is retained in the second retentate; and wherein the second COF membrane has a smaller pore size relative to the first COF membrane.
